SEQUENCE LISTING (4 sequences)

SEQ ID NO: 1 - DNA, 498 bp, Xanthomonas campestris
atgcaccatcatcatcatcattcttctggtctggtgccacgcggttctggtatgaaagaaaccgctgctgctaaattcgaacgccagcacatggacagcccagatctgggtaccgacgacgacgacaaggccatggcgatctacgctgcacgcccagggcacaccgcgccagcgcatactgcccggcgatcaatccggataacgacaatgaacaaagcacgtcttctgctactgccgttactgttgctcggcggctgtgccaccagcggcggcgaccgcgccggtggcgatatcccggctggcgccgatgtcaccagcaagaccatgggcaatggcgacaaggtcgacgaataccgcgtcaacggccagctggagatggtgcgggtgacgccagcgcgcggggcgccctacttcctgtacgaccgcgaccacgacggccataccgacgcggaaaaggacaaggtcaacaaggtgtattggcagctctatagctggtga

SEQ ID NO: 2 - DNA, 639 bp, Xanthomonas campestris
ctcgccctggccgtgctggccgcgctgtccgctggcaccgcattcgccgccaccgtgccggctcccggcgatgcgccgcggcctgccaagctcgacaagaacggcgatggcgtgatcgaccgcagcgaagcggctgccgatccgacgctggccgcgcagttcgatacgttggacaccaacaaggacggcaagctgtcgcgcgacgagcgcccgcatcatcgtggccctgggcgcgatgggcgcggcggacgtggcggacgtggcgaatggatggccaagctcgataccaacaaggatggccgtatcagccgcgaagaagccaaggccgcccccaagttcgctgcacgcttcgaccagatggatctcaacaaggacggcttcgtcgaccgtgccgaccgtgagttgcgcatgcagcagcatcgcgacgcgtggtttgccaaggccgataccgacaaggacggcaagctgagcaaggccgagttcgatgccgcgtccaagtggcgtggcgggcacggaccgggtgggatgggcaggcacggcgacgatggcaagccggcaccgccgccgcacctgcgacgaaccgctgaggcatcgccgactgcggcactcgttgcgtattggcgagtgccgcttgggtga

SEQ ID NO: 3 - protein, 165 aa, Xanthomonas campestris
MHHHHHHSSGLVPRGSGMKETAAAKFERQHMDSPDLGTDDDDKAMAIYAARPGHTAPAHTARRSIRITTMNKARLLLLPLLLLGGCATSGGDRAGGDIPAGADVTSKTMGNGDKVDEYRVNGQLEMVRVTPARGAPYFLYDRDHDGHTDAEKDKVNKVYWQLYSW

SEQ ID NO: 4 - protein, 212 aa, Xanthomonas campestris
LALAVLAALSAGTAFAATVPAPGDAPRPAKLDKNGDGVIDRSEAAADPTLAAQFDTLDTNKDGKLSRDERPHHRGPGRDGRGGRGGRGEWMAKLDTNKDGRISREEAKAAPKFAARFDQMDLNKDGFVDRADRELRMQQHRDAWFAKADTDKDGKLSKAEFDAASKWRGGHGPGGMGRHGDDGKPAPPPHLRRTAEASPTAALVAYWRVPLG

(19) United States
(12) Patent Application Publication
(10) Pub. No.: US 2009/0247422 A1
(43) Pub. Date: Oct. 1, 2009

(54) In SITU Induced Antigen Technology (ISIAT) for Identification of Polynucleotides Expressed during Infection or Colonization

(75) Inventor: Jeffrey Daniel Hillman, Gainesville, FL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Oragenics, Inc.

(21) Appl. No.: 12/327,056

(22) Filed: Dec. 3, 2008

Related U.S. Application Data
(62) Division of application No. 10/505,054, filed on Jun. 3, 2005, now abandoned.
(60) Provisional application No. 60/358,778, filed on Feb. 22, 2002.

(51) Int. Cl. C40B 30/04

(52) U.S. Cl. 506/9

(57) ABSTRACT

The invention provides compositions and methods for identifying polynucleotides and polypeptides expressed by a microbe during infection or colonization. The invention also provides compositions and methods for identifying polynucleotides and polypeptides expressed by a host organism in response to a disease state. The invention also provides methods and compositions for the diagnosis, treatment, prevention, and amelioration of diseases and infections caused by microbes.

### PRIORITY

This application is a divisional application of U.S. Ser. No. 10/505,054, filed on Jun. 3, 2005, which is a U.S. National Application under 35 U.S.C. § 371 of PCT/US2003/005253, filed Feb. 24, 2003, which claims the benefit of U.S. Provisional App. No. 60/358,778 filed Feb. 22, 2002, all of which are incorporated by reference herein in their entirety.

### TECHNICAL AREA OF THE INVENTION

This invention provides methods and compositions for isolating and identifying microbial polynucleotides specifically expressed during infection or colonization. The invention also provides methods and compositions for isolating and identifying host resistance factors. The invention also provides methods and compositions for the diagnosis, treatment, prevention and amelioration of diseases and infections caused by microbes.

### BACKGROUND OF THE INVENTION

In vivo induced antigen technology (IVIAT) is methodology used to identify polynucleotides of microbes that are specifically induced during infection of a host that is capable of mounting a humoral (antibody) immune response. See WO 01/11081. The identified polynucleotides are likely important targets for development of new vaccine and diagnostic strategies.

Methods are still needed for identification of microbial polynucleotides that are specifically induced during infection of a host or colonization of an object where the host or object is not capable of mounting a humoral immune response, or it is not convenient or possible to induce an infection in a host that is capable of mounting a humeral response.

### SUMMARY OF THE INVENTION

It is an object of the invention to provide methods for identifying polynucleotides and polypeptides useful for diagnostics and anti-biotherapy. This and other objects of the invention are provided by one or more of the embodiments described below.

One embodiment of the invention provides a method of isolating a polynucleotide of a microbe that is expressed during infection of a plant. The method comprises obtaining a plant tissue that is infected with the microbe; immunizing an animal with the infected plant tissue; collecting antibodies from the immunized animal; adsorbing the antibodies with cells or extracts of the microbe grown in vitro; isolating unadsorbed antibodies; and probing an expression or display library of the microbe's DNA or RNA with the unadsorbed antibodies. A polynucleotide of the microbe that is specifically expressed during infection of a plant and not during growth under laboratory conditions is thereby isolated. The method can further comprise the step of determining the nucleotide sequence of the isolated polynucleotide. In addition, polypeptide can be expressed from the isolated polynucleotide. An antibody specific for the polypeptide can be generated.

The animal can be selected from, for example, the group consisting of humans, baboons, chimpanzees, macaques, cattle, sheep, pigs, horses, goats, dogs, cats, rabbits, guinea pigs, rats, mice, chickens, ducks, fish, and shellfish.

The plant tissue can be obtained from one or more plants. The plant tissue can comprise a plurality of plant tissues that are collected at different time points during microbial infection of the plant. The plant can be selected from, for example, the group consisting of algae, bryophytes, tracheophytes and angiosperms. The plant tissue can be selected from the group consisting of a leaf, root, stem, flower, seed, and fruit. The microbe can be selected from the group consisting of a bacterium, a virus, a viroid, a parasite, a yeast, and a fungus.

The step of immunizing can comprise immunizing the animal with a composition comprising a plant tissue that has been homogenized and an adjuvant. The expression or display library can be a plasmid genomic expression or display library, bacteriophage expression or display library or a cell based expression or display library.

The step of probing a displayed library can comprise immobilizing the unadsorbed antibodies on a solid support, adding the displayed library of the microbe's DNA or RNA to the solid support, washing unbound members of the displayed library from the solid support; and recovering members of the displayed library that are bound to the solid support. The members of the library can be phage particles displaying polypeptides expressed by cloned polynucleotides. The solid support can optionally be blocked with a blocking agent before the library is added. The solid support can be selected from the group consisting of nitrocellulose, nylon, polystyrene, polyvinylchloride, latex, fiberglass, glass, microsphere, liposome, sepharose, sephadex, and a magnetic particle.

Another embodiment of the invention provides a method of comparing polynucleotides of a microbe that are expressed in vivo during infection of a plant at different stages of infection. The method comprises immunizing an animal with a first sample comprising one or more plant tissues that are infected with a microbe, wherein each of the one or more plant tissues is in about the same stage of microbial infection, collecting antibodies from the immunized animal, adsorbing the antibodies with extracts or cells of the microbe grown in vitro, and isolating unadsorbed antibodies. An animal is immunized with a second sample comprising one or more plant tissues that are infected with a microbe, wherein each of the one or more plant tissues is in about the same stage of microbial infection, wherein the stage of infection is different from the stage of infection of the first sample, collecting antibodies from the immunized animal, adsorbing the antibodies with extracts or cells of the microbe grown in vitro, and isolating unadsorbed antibodies. An expression or display library of the microbe is probed with the unadsorbed antibodies from the first sample, and is probed with the unadsorbed antibodies from the second sample, wherein polynucleotides of the microbe that are expressed in vivo are identified for the first sample and the second sample. The polynucleotides of the microbe that are expressed in vivo at different stages of infection of the microbe are compared. The polynucleotides of the microbe that are expressed in vivo at different stages of infection of the microbe can be sequenced. The libraries can be the same.

Still another embodiment of the invention provides a method of isolating a polynucleotide of a microbe that is expressed under a first environmental condition and not under a second environmental condition. The method comprises obtaining a sample of the microbe grown under the first condition; immunizing an animal with the microbe sample; collecting antibodies from the immunized animal; adsorbing the antibodies with extracts or cells of the microbe; isolating unadsorbed antibodies; and probing an expression or display library of the microbe's DNA or RNA with the unadsorbed antibodies. A polynucleotide of the microbe that is expressed under the first condition and not under a second condition is isolated. The nucleic acid sequence of the polynucleotide can be determined. A polypeptide can be expressed from the isolated polynucleotide. An antibody specific for the polypeptide can be generated.

The microbe sample can be selected from the group consisting of microbial cells, microbial cell extracts, and microbial cells and microbial cell extracts.

The animal can be selected from the group consisting of humans, baboons, chimpanzees, macaques, cattle, sheep, pigs, horses, goats, dogs, cats, rabbits, guinea pigs, rats, mice, chickens, ducks, fish, and shellfish. The microbe can be selected from the group consisting of a bacterium, a virus, an algae, a parasite, a prion, a protozoan, a yeast, and a fungus. The first environmental condition can be a natural biofilm or an artificial biofilm. The natural or artificial biofilm can be formed on an inanimate object or an animal tissue. The second environmental condition is selected from the group consisting of normal in vitro growth conditions, optimal in vitro growth conditions, or planktonic growth phase conditions. The sample of the microbe grown under natural biofilm or artificial biofilm conditions can be obtained from more than one biofilm site. The first environmental condition can also be selected from the group consisting of exposure to extreme heat, exposure to extreme cold, exposure to toxic chemicals, exposure to toxic metals, exposure to radiation, exposure to toxins, exposure to antibiotics, exposure to bacteriocides, exposure to viricides, exposure to bacteriostatic agents, exposure to viristatic agents, exposure to low oxygen conditions, exposure to high oxygen conditions, exposure to high pH, exposure to low pH, exposure to iron, exposure to low levels of nutrients, and exposure to high levels of nutrients. The second environmental condition can be normal in vitro growth conditions or optimal in vitro growth conditions.

The sample of the microbe grown under the first condition can comprise a plurality of microbe samples that are collected at different time intervals.

Yet another embodiment of the invention comprises a method of comparing polynucleotides of a microbe that are expressed under a first environmental condition at different stages of colonization. The method comprises immunizing an animal with a first sample comprising one or more microbial samples grown under a first environmental condition, wherein each of the one or more microbial samples is in about the same stage of microbial colonization, collecting antibodies from the immunized animal, adsorbing the antibodies with extracts or cells of the microbe grown under a second environmental condition, and isolating unadsorbed antibodies. An animal is immunized with a second sample comprising one or more microbial samples grown under a first environmental condition, wherein each of the microbial samples is in about the same stage of microbial colonization, wherein the stage of colonization is different from the stage of colonization in the first sample, collecting antibodies from the immunized animal, adsorbing the antibodies with extracts or cells of the microbe, and isolating unadsorbed antibodies. A first expression or display library of the microbe is probed with the unadsorbed antibodies from the first sample, and a second expression or display library is probed with the unadsorbed antibodies from the second sample. Polynucleotides of the microbe that are expressed under the first environmental condition are identified for the first sample and the second sample. The polynucleotides of the microbe that are expressed under a first environmental condition at different stages of colonization of the microbe are compared.

The polynucleotides of the microbe that are expressed under a first environmental condition at different stages of infection of the microbe can be sequenced. The expression or display libraries can be the same expression or display library.

Another embodiment of the invention provides a method of identifying a polynucleotide expressed by a host in response to a disease state. The method comprises obtaining a diseased tissue sample from the host, immunizing an animal with the diseased tissue sample, collecting antibodies from the immunized animal, adsorbing the antibodies with cells or cell extracts of a healthy host tissue, isolating unadsorbed antibodies; and probing an expression or display library of the host's DNA with the unadsorbed antibodies. A polynucleotide of the host that is expressed in response to the disease state is identified.

The healthy host tissue can be obtained from the same diseased host. The healthy host tissue can be obtained from a host that differs from the diseased host. The healthy host tissue can be obtained from a host that differs from the diseased host, but is of the same species. The immunized animal can be a different type of animal than the host. The immunized animal can be distantly related to the diseased host.

The diseased host can be a plant, a bacterium or an animal. An animal can be a mammal or other animal such as a chicken, duck, fish or shellfish. The disease can be selected from the group consisting of cancer, a viral disease, a bacterial disease, a fungal disease, a disease caused by a prion, a disease caused by a protozoan, and a parasitic disease.

The identified polynucleotide can be confirmed as expressed by the host in response to the disease. A polypeptide can be expressed and isolated from the identified polynucleotide. Antibodies can be generated against the polypeptide. Diseased tissue of the host or another diseased host is probed with the generated antibodies. The identified polynucleotide is confirmed as being expressed by the host in response to the disease if the antibodies react with the diseased tissue.

Another embodiment of the invention provides an isolated polynucleotide comprising a sequence substantially identical to SEQ ID NO:1. The polynucleotide can be isolated from Xanthomonas campestris. The polynucleotide can be operably linked to an expression control sequence. The polynucleotide can also be part of a heterologous polynucleotide. The polynucleotide can be in an expression vector and the expression vector can be in a host cell. The invention also provides a polypeptide encoded by one of the polynucleotides including the polynucleotides comprising a sequence substantially identical to SEQ ID NO:1; the polynucleotides operably linked to an expression control sequence; and the polynucleotides in the expression vector.

Another embodiment provides a polypeptide comprising the amino acid sequence of SEQ ID NO:3. The invention also provides an isolated immunogenic polypeptide comprising at least about 5 contiguous amino acids of an amino acid sequence of SEQ ID NO:3. The immunogenic polypeptide can be part of an isolated polypeptide which also comprises a heterologous polypeptide.

Still another embodiment of the invention provides an antibody, antibody fragment, or single-chain antibody that specifically binds to an isolated immunogenic polypeptide comprising at least about 5 contiguous amino acids of an amino acid sequence of SEQ ID NO:3. The antibody fragment can be selected from the group consisting of Fab, F(ab′)₂, Fab′ and Fab′-SH. The antibody can be a monoclonal antibody or a polyclonal antibody.

Yet another embodiment of the invention provides a method for detecting the presence of a first Xanthomonas campestris polynucleotide in a test sample comprising contacting a test sample suspected of containing the first polynucleotide with a second polynucleotide under hybridization conditions, wherein the second polynucleotide is a polynucleotide of SEQ ID NO:1, or the complement thereof, detecting a hybridized first and second polynucleotide complex, wherein the presence of a hybridized first and second polynucleotide complex indicates the presence of a first polynucleotide in the test sample.

Still another embodiment of the invention provides a method of detecting the presence of a Xanthomonas campestris polypeptide in a test sample comprising contacting a test sample with an antibody that specifically binds to a polypeptide of SEQ ID NO:3, or a fragment thereof, under conditions that allow formation of an immunocomplex between the antibody and the Xanthomonas campestris polypeptide; and detecting an immunocomplex, wherein detection of the immunocomplex indicates the presence of Xanthomonas campestris polypeptide in the test sample. The antibody can specifically bind to the Xanthomonas campestris polypeptide.

Another embodiment of the invention provides a method of detecting Xanthomonas campestris infection in a subject comprising obtaining a biological sample from the subject; contacting the biological sample with the antibody, antibody fragment, or single-chain antibody that specifically binds to a polypeptide of SEQ ID NO:3, or a fragment thereof, under conditions that allow formation of immunocomplexes between the antibody, antibody fragment, or single-chain antibody and Xanthomonas campestris polypeptides present in the biological sample; detecting the amount of immunocomplexes formed; and comparing the amount of immunocomplexes detected to a control sample; wherein a higher amount of immunocomplexes in the biological sample than in the control sample indicates a Xanthomonas campestris infection in the subject. The subject can be a plant.

Even another embodiment of the invention provides a method of detecting Xanthomonas campestris infection in a subject comprising obtaining a biological sample from the subject; contacting the biological sample with the polynucleotide of SEQ ID NO:1 or the complement thereof under conditions that allow formation of a hybridized complex; detecting the amount of hybridized complex formed; and comparing the amount of hybridized complex detected to a control sample; wherein a higher amount of hybridized complex in the biological sample than in the control sample indicates a Xanthomonas campestris infection in the subject.

Still another embodiment of the invention provides a method of treatment or preventing a disease caused by Xanthomonas campestris comprising administering to a plant a biological agent capable of treating or preventing a disease caused by Xanthomonas campestris. The biological agent can specifically binds to polypeptide comprising an amino acid sequence of SEQ ID NO:3. The biological agent can modulate the activity or expression of a protein comprising the sequence of SEQ ID NO:3. The biological agent can also inhibit the activity or expression of a protein comprising the sequence of SEQ ID NO:3. The disease can be bean blight.

Yet another embodiment of the invention provides a method of identifying a compound as a biological agent capable of treating or preventing a disease caused by Xanthomonas campestris comprising obtaining a first biological sample from a subject infected with Xanthomonas campestris; exposing the subject to a compound; obtaining a second biological sample from the subject after exposure to the compound; contacting the first and second biological samples separately with the antibody, antibody fragment, or single-chain antibody that specifically binds to a polypeptide of SEQ ID NO:3, or a fragment thereof, under conditions that allow formation of immunocomplexes between the antibody, antibody fragment, or single-chain antibody and Xanthomonas campestris polypeptides present in the biological sample; and comparing the amount of immunocomplexes detected in first biological sample to the amount of immunocomplexes detected in the second biological sample; wherein a lesser or equal amount of immunocomplexes in the second biological sample than in the first biological sample indicates a compound that is a biological agent capable of treating or preventing a disease caused by Xanthomonas campestris. This biological agent can be used in a method to treat or prevent a disease caused by Xanthomonas campestris.

Another embodiment of the invention provides an isolated polynucleotide comprising a sequence substantially identical to SEQ ID NO:2. The polynucleotide can be isolated from Xanthomonas campestris. The polynucleotide can be operably linked to an expression control sequence. The polynucleotide can also be part of a heterologous polynucleotide. The polynucleotide can be in an expression vector and the expression vector can be in a host cell. The invention also provides a polypeptide encoded by one of the polynucleotides including the polynucleotides comprising a sequence substantially identical to SEQ ID NO:2; the polynucleotides operably linked to an expression control sequence; and the polynucleotides in the expression vector.

Another embodiment provides a polypeptide comprising the amino acid sequence of SEQ ID NO:4. The invention also provides an isolated immunogenic polypeptide comprising at least about 5 contiguous amino acids of an amino acid sequence of SEQ ID NO:4. The immunogenic polypeptide can be part of an isolated polypeptide which also comprises a heterologous polypeptide.

Still another embodiment of the invention provides an antibody, antibody fragment, or single-chain antibody that specifically binds to an isolated immunogenic polypeptide comprising at least about 5 contiguous amino acids of an amino acid sequence of SEQ ID NO:4. The antibody fragment can be selected from the group consisting of Fab, F(ab′)₂, Fab′ and Fab′-SH. The antibody can be a monoclonal antibody or a polyclonal antibody.

Yet another embodiment of the invention provides a method for detecting the presence of a first Xanthomonas campestris polynucleotide in a test sample comprising contacting a test sample suspected of containing the first polynucleotide with a second polynucleotide under hybridization conditions, wherein the second polynucleotide is a polynucleotide of SEQ ID NO:2, or the complement thereof, detecting a hybridized first and second polynucleotide complex, wherein the presence of a hybridized first and second polynucleotide complex indicates the presence of a first polynucleotide in the test sample.

Still another embodiment of the invention provides a method of detecting the presence of a Xanthomonas campestris polypeptide in a test sample comprising contacting a test sample with an antibody that specifically binds to a polypeptide of SEQ ID NO:4, or a fragment thereof, under conditions that allow formation of an immunocomplex between the antibody and the Xanthomonas campestris polypeptide; and detecting an immunocomplex, wherein detection of the immunocomplex indicates the presence of Xanthomonas campestris polypeptide in the test sample. The antibody specifically binds to the Xanthomonas campestris polypeptide.

Another embodiment of the invention provides a method of detecting Xanthomonas campestris infection in a subject comprising obtaining a biological sample from the subject; contacting the biological sample with the antibody, antibody fragment, or single-chain antibody that specifically binds to a polypeptide of SEQ ID NO:4, or a fragment thereof, under conditions that allow formation of immunocomplexes between the antibody, antibody fragment, or single-chain antibody and Xanthomonas campestris polypeptides present in the biological sample; detecting the amount of immunocomplexes formed; and comparing the amount of immunocomplexes detected to a control sample; wherein a higher amount of immunocomplexes in the biological sample than in the control sample indicates a Xanthomonas campestris infection in the subject. The subject can be a plant.

Even another embodiment of the invention provides a method of detecting Xanthomonas campestris infection in a subject comprising obtaining a biological sample from the subject; contacting the biological sample with the polynucleotide of SEQ ID NO:2 or the complement thereof under conditions that allow formation of a hybridized complex; detecting the amount of hybridized complex formed; and comparing the amount of hybridized complex detected to a control sample; wherein a higher amount of hybridized complex in the biological sample than in the control sample indicates a Xanthomonas campestris infection in the subject.

Still another embodiment of the invention provides a method of treatment or preventing a disease caused by Xanthomonas campestris comprising administering to a plant a biological agent capable of treating or preventing a disease caused by Xanthomonas campestris. The biological agent can specifically binds to polypeptide comprising an amino acid sequence of SEQ ID NO:4. The biological agent can modulate the activity or expression of a protein comprising the sequence of SEQ ID NO:4. The biological agent can also inhibit the activity or expression of a protein comprising the sequence of SEQ ID NO:4. The disease can be bean blight.

Yet another embodiment of the invention provides a method of identifying a compound as a biological agent capable of treating or preventing a disease caused by Xanthomonas campestris comprising obtaining a first biological sample from a subject infected with Xanthomonas campestris; exposing the subject to a compound; obtaining a second biological sample from the subject after exposure to the compound; contacting the first and second biological samples separately with the antibody, antibody fragment, or single-chain antibody that specifically binds to a polypeptide of SEQ ID NO:4, or a fragment thereof, under conditions that allow formation of immunocomplexes between the antibody, antibody fragment, or single-chain antibody and Xanthomonas campestris polypeptides present in the biological sample; and comparing the amount of immunocomplexes detected in first biological sample to the amount of immunocomplexes detected in the second biological sample; wherein a lesser or equal amount of immunocomplexes in the second biological sample than in the first biological sample indicates a compound that is a biological agent capable of treating or preventing a disease caused by Xanthomonas campestris. This biological agent can be used in a method to treat or prevent a disease caused by Xanthomonas campestris.

### DETAILED DESCRIPTION OF THE INVENTION

### Isolation of a Polynucleotide of a Microbe Expressed During Infection or Colonization

One embodiment of the invention provides a method for isolating a polynucleotide of a microbe that is specifically expressed during infection or colonization of a plant, but not expressed under non-infectious conditions. In general, a plant tissue infected with a microbe is obtained and used to immunize an animal. Antibodies are collected from the immunized animal and adsorbed with cells or extracts of the microbe grown under non-infectious conditions, for example, in vitro growth. Unadsorbed antibodies are isolated and used to probe an expression or display library of the microbe's DNA or RNA. In this manner, a polynucleotide of the microbe that is specifically expressed during infection of a plant is isolated.

By “specifically expressed” is meant that the polynucleotide is expressed to a greater or lesser extent under a first environmental condition as compared with a second environmental condition. For example, the polynucleotide might be expressed under a first environmental condition but not expressed under a second environmental condition. Alternatively, the polynucleotide might be expressed to a greater extent, for example 10%, 20%, 50%, 100%, 200%, or more, in the first environmental condition as compared to the second environmental condition.

Another embodiment of the invention provides methods for isolating a polynucleotide of a microbe that is expressed under a first environmental condition and not under a second environmental condition. A sample of the microbe grown under the first condition is obtained. An animal is immunized with the microbe sample. Antibodies from the immunized animal are collected. The antibodies are adsorbed with extracts of the microbe grown under the second condition. Unadsorbed antibodies are isolated. An expression or display library of the microbe's DNA or RNA is probed with the unadsorbed antibodies. A polynucleotide of the microbe that is expressed under the first condition and not under a second condition is isolated.

Samples from infected plant tissues or from microbes grown under a first environmental condition are collected and processed immediately for immunization or are quickly frozen for later processing to preserve as closely as possible all of the potential epitopes that were present at the site of infection or colonization at the moment the sample was taken. Individual samples or pooled samples collected at different time intervals or from different infectious sites or colonization sites are used to immunize an animal to obtain an antibody response.

Any kind of animal can be used for immunization. For example, an animal can be a mammal such as a human, baboon, chimpanzee, macaque, cattle, sheep, pig, horse, goat, dog, cat, rabbit, guinea pig, rat, and mouse. An animal can also be a non-mammal, for example, a chicken, duck, fish, and shellfish.

The immunization of animals with an antigen sample for the production of antibodies is well known in the art. See e.g., Antibody Techniques, Malik & Lillehoj, eds., Academic Press (1994); Antibodies: A Laboratory Manual, Harlow & Lane, eds., Cold Spring Harbor Laboratories (1988). A sample can be homogenized before administration to an animal. Administration can be by, for example, intramuscular, interperitoneal, subcutaneous, intradermal, intravenous, or nasal/inhalation, or combinations thereof.

The animal or animals are immunized with a sample or samples of a plant tissue or a sample or samples of a microbe grown under a first environmental condition. The administration of the sample to the animal can be combined with an adjuvant. Alternatively, an adjuvant can be administered to the animal separately. An adjuvant can enhance an immune response to an antigen. An adjuvant can be, for example, complete Freund's adjuvant (CFA), Incomplete Freund's Adjuvant (IFA), montanide ISA (incomplete Seppic adjuvant), Ribi Adjuvant System (RAS), TiterMax®, Syntex Adjuvant Formulation (SAF), aluminum salt adjuvants, nitrocellulose-adsorbed antigen, encapsulated or entrapped antigens, immune-stimulating complexes (ISCOMs), for example Quil A or QS-21, and Gerbu® adjuvant. One of skill in the art can choose an appropriate adjuvant for a particular sample.

Booster administrations of the samples of plant tissue or a microbe grown under a first environmental condition can be given to the animal at, for example, 2 weeks, 1 month, two months, or three months after the immunization.

After an immune response occurs in the animal, an antibody sample is collected from the immunized animal. The sample can comprise, for example, the serum of an immunized animal. The animal's serum will contain antibodies, including antibodies specific for microbial antigens expressed during in vivo infection of a plant or for microbial antigens expressed under a first environmental condition. Antibodies collected from an individual immunized animal can be used or antibodies pooled from two or more animals can be used. For example, antibodies collected from about 2, 5, 25, 100, 500, or 1,000 animals can be pooled.

Antibodies that bind to antigens that are produced under a non-infectious or second environmental condition, e.g., in vitro propagation of the microbe of interest, are eliminated from the sample of antibodies. The antibodies that are produced under non-infectious conditions or a second environmental condition can be removed from the sample by, for example, adsorption. The result is an “unadsorbed antibody” sample. In one embodiment of the invention, an antibody sample is adsorbed with whole cells, cell extracts, or both, of the microbe grown under non-infectious conditions or a second environmental condition.

The adsorption step can be performed by, for example, contacting the antibody sample with whole cells and/or cell extracts that are immobilized on a solid support, such as a nitrocellulose membrane or latex beads. See, Brady & Daphtary, J. Infect. Dis. 158:965-972 (1988). Optionally, the whole cell and/or cell extract sample can be denatured before use to expose additional immunoreactive epitopes. Two or more successive adsorptions can be performed using the same or different adsorption methodologies.

All or substantially all of the antibodies in the antibody sample whose corresponding antigens are derived from microbes grown under a second environmental condition or under non-infectious conditions will bind to these antigens to form immune complexes. However, antibodies directed against antigens that are specifically expressed under the first environmental condition or under infectious conditions will remain uncomplexed since their corresponding antigens are not present in the cells and/or cell extracts grown under the second environmental condition or under non-infectious conditions. The uncomplexed antibodies comprise an unadsorbed antibody sample.

After elimination of all or substantially all of antibodies specific for antigens produced by microbes under non-infectious growth or under a second environmental condition, the unadsorbed antibody sample will comprise antibodies reactive with antigens specifically produced during a microbial infection or a microbial colonization. This sample can then be used to screen one or more, same or different, genomic expression libraries, for example, plasmid or bacteriophage genomic expression libraries, of the microbe of interest. An expression library is any vector and host system in which a cloned fragment of a nucleic acid is transcribed and translated to yield a protein product. Methods of constructing genomic expression libraries are well known in the art. See, e.g., Ausubel (ed.), Current Protocols in Molecular Biology, John Wiley and Sons, Inc. (1994); T. Maniatis, E. F. Fritsch and J. Sambrook, Molecular Cloning: A Laboratory Manual, Cold Spring Harbor laboratory, Cold Spring Harbor, N.Y. (1989). Optionally, DNA, cDNA, or RNA from more than one strain of the microbe of interest can be pooled for expression library construction. In one embodiment, a genomic expression library of a microbe's DNA can be constructed in a pET30 or similar vector. After induction, a library can be screened by, for example, a colony lift method, using an antibody sample that has had antibodies specific for a second environmental condition or antibodies specific for non-infectious conditions removed, as a primary probe that is then developed using a secondary antibody. The secondary antibody can be labeled with, for example, radioactivity, enzymes, fluorescent compounds, and chemiluminescent compounds.

In another embodiment of the invention, a phage display library of the microbe's DNA can be constructed. A display library is any vector and host system in which a cloned fragment of a nucleic acid is transcribed and translated to yield a protein product, wherein the protein product is transferred to the surface of the host, where it is exhibited to the surrounding environment. For example, a vector such as bacteriophage T7 select 10-3 (Novagen, Madison, Wis.) can be used to construct the phage display library. Unadsorbed antibodies are immobilized on a solid support. A solid support can be any solid material to which an antibody can be attached, for example, a microtiter plate, nitrocellulose, nylon, a plastic material, for example, polystyrene or polyvinylchloride, latex, fiberglass, glass, microsphere, liposome, sepharose, and sephadex. A solid support can also be a magnetic particle or an optical biosensor. Antibodies can be immobilized onto the solid support using any means known in the art, including, for example, physical adsorption (i.e., without the use of chemical linkers) or chemical binding (i.e., with the use of chemical linkers). Chemical binding can generate strong attachment of antibodies on a solid support and provide defined orientation and conformation of the surface-bound molecules.

The solid support can optionally be subjected to a blocking step to reduce non-specific attachment of members of the display library to the solid support. A blocking solution can comprise, for example, treatment with 0.25% Tween-20™, or 1% bovine serum albumin, or 1% gelatin. The display library is added to the solid support. In one embodiment of the invention, a phage display library, (typically 10⁶ to 10⁹ plaque forming units, pfu) is added to the solid support and incubated to allow attachment of antibody to the microbe's proteins that are displayed on the phage capsid protein. Unbound phage are washed away from the solid support and bound phage are recovered. This “biopanning” procedure can be repeated one, two, three, or more additional times to increase the proportion of recovered display library members that expressing microbial antigens induced under a first environmental condition or under infectious conditions.

Other methods for screening these libraries with one or more labeled or unlabeled antibody-containing samples and for identifying and isolating clones from the library that encode the reactive antigens of interest are also well known in the art, e.g., colony blotting methods See, e.g., Ausubel (1994); Maniatis (1989).

Reactive clones identified by screening expression or display libraries of the microbe of interest can be characterized by conventional analysis. “Clones” are phage particles or bacterial colonies of the microbe's genetic library. A reactive clone is a clone that reacts with one or more unadsorbed antibodies. For example, a reactive clone can react with one or more unadsorbed antibodies by producing a polypeptide that specifically binds to an unadsorbed antibody. A microbial polynucleotide from the reactive clone can be isolated using methods well known to those of ordinary skill in the art. A polynucleotide from a reactive clone can be placed into an expression vector so that a polypeptide is expressed by the polynucleotide. The polypeptide can be isolated and purified. In another embodiment, the reactive clone can produce a polypeptide from a microbial polynucleotide. The polypeptide can then be isolated and purified.

A microbial insert of a reactive clone can be sequenced and the presence of open reading frames can be predicted, for example, using Fickett's, start/stop codon or other methods. See, e.g., Fickett, Nucleic Acids Res. 10:5303-5318 (1982); Solovyev, Nucleic Acids Res. 22:5156-5163 (1994); Saqi, Protein Eng. 8:1069-1073 (1995), Ladunga and Smith, Protein Eng. 20:101-110 (1997); Birney, Nucleic Acids Res. 24:2730-2739 (1996).

Identification of signal sequences, particularly likely ribosome binding sites and transcription termination sequences, can also be made. The information provided by these analyses can also be helpful in prioritizing the subcloning of open reading frames if more than one is present on a cloned insert. Moreover, the obtained sequence information can be used to identify sequence similarities to known polynucleotides, e.g., by BLAST analysis, and to identify possible relationships to proven or putative host resistance factors. In instances where more than one open reading frame is present on a cloned insert, all of the open reading frames can be analyzed for their ability to express antigens produced under infectious conditions or under a first environmental condition. For example, each open reading frame can be independently subcloned and tested with an unadsorbed antibody sample to identify antigens induced in infectious conditions or under first environmental conditions. A polynucleotide of the invention can be used, for example, to develop treatment methodologies such as ribozymes or antisense molecules. A polynucleotide can also be used as a labeled or unlabeled probe to diagnose a disease or to identify the presence of a microbe in a sample.

Polypeptides can be expressed from microbial, plant, human or animal polynucleotides. The polypeptides can then be used to generate antibodies that specifically bind to an immunological epitope present in the polypeptides of the invention. Antibodies of the invention are antibody molecules that specifically bind to a microbial polypeptide of the invention or fragment thereof. An antibody of the invention can be a polyclonal antibody, a monoclonal antibody, a single chain antibody (scFv), or a part of an antibody. Parts of antibodies include Fab and F(ab)₂ fragments. Antibodies can be made in vivo in suitable laboratory animals or in vitro using recombinant DNA techniques. Means for preparing and characterizing antibodies are well known in the art. See, e.g., Dean, Methods Mol. Biol. 80:23-37 (1998); Dean, Methods Mol. Biol. 32:361-79 (1994); Baileg, Methods Mol. Biol. 32:381-88 (1994); Gullick, Methods Mol. Biol. 32:389-99 (1994); Drenckhahn et al. Methods Cell. Biol. 37:7-56 (1993); Morrison, Ann. Rev. Immunol. 10:239-65 (1992); Wright et al. Crit. Rev. Immunol. 12:125-68 (1992). For example, polyclonal antibodies can be produced by administering polypeptide of the invention to an animal, such as a mouse, a rabbit, a goat, or a horse. Serum from the immunized animal is collected and the antibodies are purified from the plasma by, for example, precipitation with ammonium sulfate, followed by chromatography, preferably affinity chromatography. Techniques for producing and processing polyclonal antibodies are known in the art.

Monoclonal antibodies directed against microbial epitopes present on a polypeptide of the invention can be produced by one skilled in the art. The general methodology for producing such antibodies is well-known and has been described in, for example, Kohler and Milstein, Nature 256:494 (1975) and reviewed in J. G. R. Hurrel, ed., Monoclonal Hybridoma Antibodies: Techniques and Applications, CRC Press Inc., Boca Raton, Fla. (1982), as well as that taught by L. T. Mimms et al., Virology 176:604-619 (1990). Immortal antibody-producing cell lines can be created by cell fusion, and also by other techniques such as direct transformation of B lymphocytes with oncogenic DNA, or transfection with Epstein-Barr virus.

Antibodies, either monoclonal or polyclonal, which are directed against microbial antigens, are particularly useful for detecting the presence of microbes or microbial antigens in a sample. An immunoassay for a microbial antigen can utilize one antibody or several antibodies. An immunoassay for a microbial antigen can use, for example, a monoclonal antibody directed towards a microbial epitope, a combination of monoclonal antibodies directed towards epitopes of one microbial polypeptide, monoclonal antibodies directed towards epitopes of different microbial polypeptides, polyclonal antibodies directed towards the same microbial antigen, polyclonal antibodies directed towards different microbial antigens, or a combination of monoclonal and polyclonal antibodies. Immunoassay protocols can be based, for example, upon competition, direct reaction, or sandwich type assays using, for example, labeled antibody. The labels can be, for example, enzymatic, fluorescent, chemiluminescent, or radioactive.

The polyclonal or monoclonal antibodies can further be used to isolate microbes or microbial antigens by immunoaffinity columns. The antibodies can be affixed to a solid support by, for example, adsorption or by covalent linkage so that the antibodies retain their immunoselective activity. Optionally, spacer groups may be included so that the antigen binding site of the antibody remains accessible. The immobilized antibodies can then be used to bind microbes or microbial antigens from a sample, such as a biological sample. The bound microbes or microbial antigens are recovered from the column matrix by, for example, a change in pH.

Antibodies of the invention can also be used in immunolocalization studies to analyze the presence and distribution of a polypeptide of the invention during various cellular events or physiological conditions. Antibodies can be detected and/or quantified using for example, direct binding assays such as, immunofluorescence, radioimmunoassay (RIA) ELISA assays or electron microscopy. Antibodies of the invention can be also be used to treat, prevent, or ameliorate a microbial infection, to diagnose or detect the presence or absence of a microbe, and to purify an antigen or antigens that the antibody specifically binds. The antibodies or fragments thereof can be employed in assay systems, such as a reversible flow chromatographic binding assay, ELISA, western blot assay, or indirect immunofluorescense assay, to determine the presence, if any, of microbial polypeptides in a test sample. In particular, the presence of microbial polypeptides that are only expressed in vivo or under certain environmental conditions can be identified. In addition, these antibodies, in particular monoclonal antibodies, can be bound to matrices including, for example, to sepharose and used for the affinity purification of specific microbial proteins from, for example, cell cultures, such as to purify recombinant and native microbial antigens and proteins. The monoclonal antibodies of the invention can also be used for the generation of chimeric antibodies for therapeutic use, or other similar applications.

Antigens induced under infectious conditions or under a first environmental condition can be directly verified as actually expressed by the microbe at the site of infection or colonization by directly probing biological samples taken from disease sites or colonization sites by any method known in the art. For example, a polynucleotide encoding a suspected antigen can be overexpressed and the resulting polypeptide purified and used to raise polyclonal antibodies. The antibodies can be labeled with, for example, fluorescein isothiocyanate (FITC), ferritin, or gold particles. A biological sample from a disease site of a host infected with the microbe of interest or from a first environmental condition is obtained. The biological sample and a matched in vitro grown sample of the microbe are assayed by, for example, immunofluorescence microscopy or immunoelectron microscopy. The labeled antibodies will react with the microbe found in the biological sample, but will not react with in vitro grown cells. These results can provide direct evidence that the microbe expresses the antigen of interest exclusively during infectious growth or during growth under a first environmental condition.

A first environmental condition can include, for example, a biofilm. A biofilm is a mass of one or more types or microorganisms that is attached to a surface, such as an inanimate object or an animal tissue. An inanimate object can include, for example, industrial equipment, such as pipes and storage tanks, and medical devices or implants. Biofilms can form, for example, on surfaces in contact with moisture, on soft tissue surfaces in living organisms, and at liquid/air interfaces. In living organisms, biofilms can occur subsequent to the implantation of, for example, bone prosthesis, heart valves, and pacemakers. A biofilm can comprise bacteria, fungi, yeasts, algae, diatoms, protozoa, and viruses. The formation of biofilms is important in diseases such as otitis media, bacterial endocarditis, cystic fibrosis, Legionnaire's disease, nosocomial disease (where microbes adhere to the surfaces of catheters, medical implants, and other medical devices). Biofilms also cause large reductions in industrial productivity by causing pipe blockage, corrosion, and water contamination. A biofilm can be a naturally occurring biofilm or can be an artificially produced biofilm.

Other examples of first environmental conditions include, but are not limited to, extreme heat, extreme cold, exposure to toxic chemicals, exposure to toxic metals, exposure to radiation, exposure to toxins, exposure to antibiotics, exposure to chemicals meant to kill or slow the growth of the microbe such as bactericides, viricides, and bacteriostatic or viristatic agents, low oxygen conditions, high oxygen conditions, low pH conditions, high pH conditions, exposure to iron, exposure to low levels of nutrients, and exposure to high levels of nutrients.

A second environmental condition can be, for example, in vitro conditions, normal in vitro conditions, and optimal in vitro conditions. Optimal in vitro conditions are the in vitro conditions known to provide for the best, most active growth of a microbe. Normal in vitro conditions are in vitro conditions that provide for good growth of a microbe, but the conditions do not have to provide for the best, most active in vitro growth. A second environmental condition can also be non-biofilm growth, i.e., where a microbe that can form or grow in a biofilm grows, instead, in planktonic phase growth, i.e., a non-biofilm manner.

An artificial infection or colonization of a microbe can be established or a natural infection or colonization of a microbe can be used. Artificially induced infections or colonizations can be useful to facilitate obtaining samples at different time intervals i.e., early, mid, and late colonization or infection, although natural infections can also be used to obtain samples at different time intervals. Artificially induced infections or colonizations can also be used in cases where more than one type of microbe can be present in the naturally occurring infection or colonization. However, to determine if other types of microbes are affecting gene expression of the microbe under study, a natural occurring infection or colonization can be used. A sample can also be obtained by combining samples from one or more infections or colonizations. A sufficient number of the microbes under study should be present in the collected samples to assure a comprehensive immune response.

Samples taken at regular intervals throughout the course of infection or colonization will assure the presence of proteins and other potentially important cell components that can be transiently expressed. The more samples that are taken, the better the likelihood that the entire array of in vivo or in situ induced components will be obtained. The samples obtained in different time stages of infection or colonization can be combined for immunization. Alternatively, they can be used to separately immunize animals to determine the approximate time during the infection or colonization that a particular protein or other cell component is expressed.

For example, comparing polynucleotides of a microbe that are expressed in vivo during infection of a plant or under a first environmental condition at different stages of infection or colonization can comprise immunizing an animal with a first sample comprising one or more plant tissues that are infected with a microbe or one or more microbial samples grown under a first environmental condition, wherein each of the one or more plants or microbial samples is in about the same stage of microbial infection. A stage of microbial infection can be, for example, early, middle, or late infection. The stage of microbial infection can be ascertained by, for example, the amount of time that has passed since infection or colonization, by the stage of a disease caused by the microbe, or by the amount of growth of the microbe. Antibodies from the immunized animal are collected and adsorbed with extracts or cells of the microbe grown under non-infectious conditions or under a second environmental condition. Adsorbed antibodies are collected.

An animal is immunized with a second sample comprising one or more plant tissues that are infected with a microbe or one or more microbial samples grown under a first environmental condition, wherein each of plant or microbial sample is in about the same stage of microbial infection or colonization, wherein the stage of infection is different from the stage of infection or colonization described above. Antibodies from the immunized animal are collected and adsorbed with the extracts or cells of the microbe grown in vitro or under a second environmental condition. Unadsorbed antibodies are collected.

An expression or display library of the microbe is probed with the first set of unadsorbed antibodies. The expression or display library is probed with the second set of unadsorbed antibodies. Polynucleotides of the microbe that are expressed in vivo or under a first environmental condition are identified for each set. The polynucleotides of the microbe that are expressed in vivo or under a first environmental condition at different stages of infection or colonization of the microbe are then compared.

Types of plants that can be used in the methods of the invention include, for example, algae, bryophytes, tracheophytes, and angiosperms. Angiosperms include, for example, flowering plants, cycads, Ginkgo biloba, and conifers. Plant tissues can include, for example, roots, leaves, stems, flowers, seeds, and fruits.

Microbes can include, for example, bacteria, including, for example, Agrobacterium, Clavibacter, Erwinia, Pseudomonas, Xanthomonas, Enterococci, Stenotrophomonas, Klebsiella, Staphylococcus, and Escherichia, phytoplasmas, mycoplasmas, protozoa, viruses, viroids, algae, diatoms, yeasts and fungi, including, for example Aspergillus, Fusarium, and Candida.

### Isolation of Host Resistance Factors

Another embodiment of the invention provides a method for identifying a polynucleotide expressed by a host in response to a disease state. These polynucleotides encode polypeptides important in resistance to infection or disease. Polynucleotides or polypeptides can be, for example, delivered to a diseased host in order to treat, ameliorate, or prevent disease. The polynucleotides and polypeptides can also be used to diagnose or monitor the progression of a disease state using assay methods such as, for example, DNA or RNA hybridization assays, ELISAs, RIAs, western blot assays, or indirect immunofluorescense assays.

The method comprises obtaining a diseased tissue sample from a host and immunizing an animal with the diseased tissue sample. A diseased tissue sample can comprise, for example, blood, serum, tumor, or tissue. Antibodies from the immunized animal are collected and adsorbed with cells or cell extracts of a healthy host tissue sample. Unadsorbed antibodies are collected and used to probe an expression or display library of the host's DNA.

A host can produce an active immune response (i.e., a humoral immune response), or can be a host that does not produce an active immune response, such as in a plant or insect. A tissue or piece of the host that is diseased is obtained. An animal is immunized with the diseased tissue or part as described above. Antibodies are collected from the immunized animal and the antibodies adsorbed with cells or cell extracts of healthy host tissue as described above. This removes antibodies that are reactive with proteins and other cell components made normally and in the absence of disease. Unadsorbed antibodies that are reactive with antigens expressed by the host only when it is diseased, are isolated and used to probe an expression or display library of the or host's DNA. Reactive clones are isolated and the cloned insert analyzed to determine the polynucleotide responsible for expressing the antigen reactive with the unadsorbed antibodies as described above. Polypeptides and antibodies can be generated as described above.

A method for identifying a polynucleotide expressed by a host in response to a disease state, where the host has an active immune system, is the same as described for hosts that do not contain an active immune system. However, additional considerations can be taken into account. For example, the evolutionary relatedness of the infected host to the host used for immunization can be taken into account. To reduce the problem of tolerance, which would diminish the spectrum of immunogenic proteins and cell components contributed by the infected host, a host used for immunization can be phylogenetically distant from the infected host. For example, in a study of a human infection, a distantly related host for immunization can be, for example, a chicken.

A diseased host can be any type of animal, for example, a mammal, such as a human, baboon, chimpanzee, macaque, cattle, sheep, pig, horse, goat, dog, cat, rabbit, guinea pig, rat, or mouse. An animal can also be, for example, a chicken, duck, insect, fish, or shellfish. A diseased host can also be a plant, insect, or unicellular organism such as algae.

An immunization host can be an animal, for example, a mammal such as a human, baboon, chimpanzee, macaque, cattle, sheep, pig, horse, goat, dog, cat, rabbit, guinea pig, rat, or mouse. An animal can also be, for example, a chicken, duck, fish, or shellfish.

A disease can be, for example, any type of microbial infection, for example, a viral disease, a bacterial disease, a fungal disease, a disease caused by a prion, a disease caused by a protozoan, and a parasitic disease. In the case of microbial infections where tissue is obtained from an infected natural host, antibodies are adsorbed with an extract of healthy cells or tissue from an uninfected host. A disease can also be a cancer. In the case of cancer, the antibodies are adsorbed with healthy tissue. In one embodiment the healthy tissue is obtained from the same diseased host. A disease can also be an autoimmune disease (e.g., arthritis), chronic inflammatory bowel disease, or diabetes.

A polynucleotide identified as produced by a host in response to a disease can be confirmed as such by expressing and isolating a polypeptide from the identified polynucleotide. Methods of expressing and isolating polypeptides from a polynucleotide are well known in the art. Antibodies to the polypeptide are produced and diseased tissue of the host or another diseased host (i.e., a host that has or is suspected of having the same disease as the original host) are probed with the antibodies. Useful assay techniques to probe diseased tissue include, for example, immunofluorescent assay, ELISA, RIA, western blot assay, or indirect immunofluorescense assay. An identified polynucleotide is confirmed as being expressed by the host in response to the disease if the antibodies react with (i.e., specifically bind) the diseased tissue or a component of the diseased tissue.

### Polypeptides

Isolated polypeptides of the invention can either be full-length polypeptides or fragments of polypeptides. For example, fragments of polypeptides of the invention can comprise at least about 5, 10, 25, 50, 100, 150 or more contiguous amino acids of polypeptides of the invention. Polypeptides of the invention can comprise or consist essentially of those shown in SEQ ID NOs:3-4. These polypeptides will be referred to as “the polypeptide SEQ IDs.” Polypeptides of the invention also can comprise or consist essentially of fragments of SEQ ID NOs:3-4. Polypeptides of the invention were discovered using ISIAT techniques. The polypeptides SEQ IDs are shown in Table 1. Where a polypeptide demonstrated homology to a known open reading frame in another species, the name of the open reading frame is given. The basic and novel characteristics of polypeptides of the invention that consist essentially of SEQ ID NOs:3-4, or fragments thereof, is that they comprise or consist essentially of the sequence shown in SEQ ID NOs:3-4, or fragments thereof, and that they specifically bind to a Xanthomonas-specific antibody, antibody fragment, single-chain antibody or aptamer of the invention.

In one embodiment of the invention, a polypeptide of the invention is immunogenic. That is, the polypeptide can elicit an immune response when it is administered to an animal.

In one embodiment of the invention, a polypeptide or fragment thereof is isolated. Isolated means that a polypeptide of the invention is substantially free from other biological molecules. A substantially isolated polypeptide is at least about 75%, 80%, 90%, 95%, 97%, 99% or 100% pure by dry weight. Purity can be measured by a method such as column chromatography, polyacrylamide gel electrophoresis, or HPLC analysis.

The invention also includes functionally active variants of polypeptides shown in SEQ ID NOs:3-4, or fragments thereof. In one embodiment, the polypeptide includes an amino acid sequence at least about 75% identical to a sequence shown as SEQ ID NOs:3-4, or a fragment thereof. The polypeptide can be at least about 75%, 80%, 85%, 90%, 95%, 98%, 99% or more identical to SEQ ID NOs:3-4, and specifically binds to a microbe-specific antibody, antibody fragment, single-chain antibody or aptamer of the invention.

Specifically binds means that the antibody recognizes and binds to a polypeptide of the invention with greater affinity than to other, non-specific molecules. For example, an antibody raised against an antigen (e.g., a polypeptide) to which it binds more efficiently than to a non-specific protein can be described as specifically binding to the antigen. Binding specifically can be tested using, for example, an enzyme-linked immunosorbant assay (ELISA), a radioimmunoassay (RIA), or a western blot assay using methodology well known in the art.

A polypeptide is a functionally active variant if it reacts substantially the same as a polypeptide shown in SEQ ID NOs:3-4 or an immunogenic fragment thereof in an assay such as an immunohistochemical assay, an ELISA, an RIA, or a western blot assay, e.g. has 90-110% of the specific binding activity of the original polypeptide. In one embodiment, the assay is a competition assay wherein the functionally active variant polypeptide is capable of reducing binding of a polypeptide shown in SEQ ID NOs:3-4, or an immunogenic fragment thereof, to a corresponding antibody, antibody fragment, single-chain antibody or aptamer by about 80, 95, 99, or 100%.

Functionally active variants can also comprise “polypeptide fragments” of the invention. Polypeptide fragments can comprise or consist essentially of about at least 5, 10, 25, 50, 75, 100, 150 or more amino acids of SEQ ID NOs:3-4.

As used herein, percent identity of two amino acid sequences (or of two nucleic acid sequences) is determined using the algorithm of Karlin and Altschul (PNAS USA 87:2264-2268, 1990), modified as in Karlin and Altschul, PNAS USA 90:5873-5877, 1993). Such an algorithm is incorporated into the NBLAST and XBLAST programs of Altschul et al. (J. Mol. Biol. 215:403-410, 1990). BLAST nucleotide searches are performed with the NBLAST program, score=100, wordlength=12. BLAST protein searches are performed with the XBLAST program, score=50, wordlength=3. To obtain gapped alignment for comparison purposes, GappedBLAST is utilized as described in Altschul et al. (Nucleic Acids Res. 25:3389-3402, 1997). When utilizing BLAST and GappedBLAST programs the default parameters of the respective programs (e.g., XBLAST and NBLAST) are used to obtain nucleotide sequences homologous to a nucleic acid molecule of the invention.

Identity or identical means amino acid sequence similarity and has an art recognized meaning. Sequences with identity share identical or similar amino acids. Thus, a candidate sequence sharing 85% amino acid sequence identity with a reference sequence requires that, following alignment of the candidate sequence with the reference sequence, 85% of the amino acids in the candidate sequence are identical to the corresponding amino acids in the reference sequence, and/or constitute conservative amino acid changes.

Functionally active variants of SEQ ID NOs:3-4, or fragments thereof, retain substantially the same functional activity of the original polypeptide or fragment. Naturally occurring functionally active variants such as allelic variants and species variants and non-naturally occurring functionally active variants are included in the invention and can be produced by, for example, mutagenesis techniques or by direct synthesis.

A functionally active variant differs by about, for example, 1, 2, 3, 4, 5, 6, 7, 8, 9, 10, 20 50, or 100 amino acid residues from a polypeptide shown in SEQ ID NOs:3-4 or a fragment thereof. Where this comparison requires alignment, the sequences are aligned for maximum homology. The site of variation can occur anywhere in the polypeptide, as long as activity substantially similar to the activity of a polypeptide shown in SEQ ID NOs:3-4, or fragments thereof, are maintained within the functionally active variant.

Guidance concerning how to make phenotypically silent amino acid substitutions is provided in Bowie et al., Science, 247:1306-1310 (1990), which teaches that there are two main strategies for studying the tolerance of an amino acid sequence to change.

The first strategy exploits the tolerance of amino acid substitutions by natural selection during the process of evolution. By comparing amino acid sequences in different species, the amino acid positions which have been conserved between species can be identified. These conserved amino acids are likely important for protein function. In contrast, the amino acid positions in which substitutions have been tolerated by natural selection indicate positions that are not critical for protein function. Thus, positions tolerating amino acid substitution can be modified while still maintaining specific binding activity of the polypeptide.

The second strategy uses genetic engineering to introduce amino acid changes at specific positions of a cloned gene to identify regions critical for protein function. For example, site-directed mutagenesis or alanine-scanning mutagenesis (the introduction of single alanine mutations at every residue in the molecule) can be used (Cunningham et al., Science, 244:1081-1085 (1989)). The resulting variant molecules can then be tested for specific binding to antibodies of the invention.

According to Bowie et al., these two strategies have revealed that proteins are surprisingly tolerant of amino acid substitutions. The authors further indicate which amino acid changes are likely to be permissive at certain amino acid positions in the protein. For example, the most buried or interior (within the tertiary structure of the protein) amino acid residues require nonpolar side chains, whereas few features of surface or exterior side chains are generally conserved.

Methods of introducing a mutation into amino acids of a protein is well known to those skilled in the art. See, e.g., Ausubel (ed.), Current Protocols in Molecular Biology, John Wiley and Sons, Inc. (1994); T. Maniatis, E. F. Fritsch and J. Sambrook, Molecular Cloning: A Laboratory Manual, Cold Spring Harbor laboratory, Cold Spring Harbor, N.Y. (1989)). Mutations can also be introduced using commercially available kits such as “QuikChange™ Site-Directed Mutagenesis Kit” (Stratagene). The generation of a functionally active variant of a polypeptide by replacing an amino acid that does not influence the function of a polypeptide can be accomplished by one skilled in the art.

A polypeptide of the invention can be isolated from cell sources using standard protein purification techniques. Polypeptides of the invention can also be synthesized chemically or produced by recombinant DNA techniques. For example, a polypeptide of the invention can be synthesized using conventional peptide synthesizers. Additionally, a polynucleotide encoding a polypeptide of the invention can be introduced into an expression vector that can be expressed in a suitable expression system using techniques well known in the art. A variety of bacterial, yeast, plant, mammalian, and insect expression systems are available in the art and any such expression system can be used. Optionally, a polynucleotide encoding a polypeptide of the invention can be translated in a cell-free translation system.

A functionally active variant polypeptide can also be isolated using a hybridization technique. Briefly, DNA having a high homology to the whole or part of a nucleic acid sequence encoding SEQ ID NOs:3-4 can be used to prepare a functionally active polypeptide. Therefore, a polypeptide of the invention also includes polypeptides that are functionally equivalent to a SEQ ID NOs:3-4 and are encoded by a nucleic acid molecule that hybridizes with a nucleic acid encoding SEQ ID NOs:3-4 or a complement thereof. For example, SEQ ID NOs:1-2 are nucleic acids encoding SEQ ID NOs. 3-4. In addition, one of skill in the art can easily determine additional nucleic acid sequences that encode polypeptides of the invention using readily available codon tables. As such, these additional nucleic acid sequences are not presented herein.

The stringency of hybridization for a nucleic acid encoding a polypeptide that is a functionally active variant is, for example, 10% formamide, 5×SSPE, 1× Denhart's solution, and 1× salmon sperm DNA (low stringency conditions). Other conditions are 25% formamide, 5×SSPE, 1× Denhart's solution, and 1× salmon sperm DNA (moderate stringency conditions), and even more conditions are 50% formamide, 5×SSPE, 1× Denhart's solution, and 1× salmon sperm DNA (high stringency conditions). However, several factors influence the stringency of hybridization other than the above-described formamide concentration, and one skilled in the art can suitably select these factors to accomplish a similar stringency.

Nucleic acid molecules encoding a functionally active variant polypeptide can also be isolated by a gene amplification method such as PCR using a portion of a nucleic acid molecule DNA encoding a polypeptide shown in SEQ ID NOs:3-4 as the probe.

Functionally active variant polypeptides of the invention can also comprise those that arise as a result of the existence of multiple genes, alternative transcription events, alternative RNA splicing events, and alternative translational and post-translational events. A polypeptide can be expressed in systems, e.g., cultured cells, which result in substantially the same post-translational modifications present as when the polypeptide is expressed in a native cell, or in systems that result in the alteration or omission of post-translational modifications, e.g., glycosylation or cleavage, present when expressed in a native cell.

A polypeptide of the invention can be produced as a fusion protein that contains other non-microbial or non-microbial-derived amino acid sequences, such as non-Xanthomonas or non-Xanthomonas-derived amino acid sequences (i.e., heterologous polypeptides), such as amino acid linkers or signal sequences, as well as ligands useful in protein purification, such as glutathione-S-transferase, histidine tag, and staphylococcal protein A. More than one polypeptide of the invention can be present in a fusion protein. The heterologous polypeptide can be fused, for example, to the N-terminus or C-terminus of the polypeptide. A polypeptide of the invention can also comprise homologous amino acid sequences, i.e., other microbe or microbe-derived sequences.

In one embodiment of the invention, functionally active variants differ from polypeptides shown in SEQ ID NOs:3-4 by only conservative amino acid substitutions, such that the antigenic properties of the polypeptide are substantially the same as the original polypeptide. These variants can generally be identified by modifying one of the polypeptide sequences of the invention, and evaluating the antigenic properties of the modified polypeptide using, for example, an immunohistochemical assay, an enzyme-linked immunosorbant assay (ELISA), a radioimmunoassay (RIA), or a western blot assay. These variants can comprise at least about 1, 5, 10, 25, 50, or 100 conservative amino acid substitutions.

A conservative amino acid substitution is one in which an amino acid is substituted for another amino acid that has similar properties, such that one skilled in the art of peptide chemistry would expect the secondary structure and hydropathic nature of the polypeptide to be substantially unchanged. In general, the following groups of amino acids represent conservative changes: (1) ala, pro, gly, glu, asp, gln, asn, ser, thr; (2) cys, ser, tyr, thr; (3) val, ile, leu, met, ala, phe; (4) lys, arg, his; and (5) phe, tyr, trp, his.

Polypeptides of the invention can be antigens that are recognized by an antibody reactive against a microbe, such as Xanthomonas. The antigen can comprise one or more epitopes (or antigenic determinants). An epitope can be a linear epitope, sequential epitope or a conformational epitope. Epitopes within a polypeptide of the invention can be identified by several methods. See, e.g., U.S. Pat. No. 4,554,101; Jameson & Wolf, CABIOS 4:181-186 (1988). For example, a polypeptide of the invention can be isolated and screened. A series of short peptides, which together span an entire polypeptide sequence, can be prepared by proteolytic cleavage. By starting with, for example, 100-mer polypeptide fragments, each fragment can be tested for the presence of epitopes recognized in an ELISA. For example, in an ELISA assay a microbial polypeptide, for example a Xanthomonas polypeptide, such as a 100-mer polypeptide fragment, is attached to a solid support, such as the wells of a plastic multi-well plate. A population of antibodies are labeled, added to the solid support and allowed to bind to the unlabeled antigen, under conditions where non-specific adsorbtion is blocked, and any unbound antibody and other proteins are washed away. Antibody binding is detected by, for example, a reaction that converts a colorless substrate into a colored reaction product. Progressively smaller and overlapping fragments can then be tested from an identified 100-mer to map the epitope of interest.

### Polynucleotides

Polynucleotides of the invention contain less than an entire genome and can be RNA or single- or double-stranded DNA or combinations or modifications thereof. The polynucleotides can be isolated free of other components, such as proteins and lipids. The polynucleotides of the invention encode the polypeptides described above, as well as fragments thereof. Polynucleotides of the invention also include those shown in SEQ ID NO:1-2 and fragments thereof. These polynucleotides will be referred to as the “polynucleotide SEQ IDs.”

One of skill in the art can obtain a polynucleotide sequence of the invention using a disclosed polypeptide sequence of the invention and codon tables. Polynucleotides can contain naturally occurring polynucleotides or sequences that differ from those of any naturally occurring sequences or polynucleotides. Polynucleotides of the invention can differ from naturally occurring nucleic acids, but still encode naturally occurring amino acids due to the degeneracy of the genetic code. These polynucleotides are degenerate variants and one of skill in the art could determine the sequences of all degenerate variant polynucleotides that encode SEQ ID NOs:3-4. As such, these sequences are not presented herein. Polynucleotides of the invention can also comprise other heterologous nucleotide sequences (i.e., heterologous polynucleotides), such as sequences coding for linkers, signal sequences, heterologous signal sequences, TMR stop transfer sequences, transmembrane domains, or ligands useful in protein purification such as glutathione-S-transferase, histidine tag, and staphylococcal protein A. Polynucleotides of the invention can also comprise other homologous nucleotide sequences, i.e., other microbe or microbe-derived sequences, for example sequences derived from Xanthomonas.

An isolated polynucleotide is a nucleic acid molecule that is not immediately contiguous with 5′ and 3′ flanking sequences with which it is normally contiguous when present in a naturally occurring genome. Therefore, an isolated polynucleotide can be, for example, a polynucleotide that is incorporated into a vector, such as a plasmid or viral vector, a polynucleotide that is incorporated into the genome of a heterologous cell (or the genome of a homologous cell, but at a site different from that where it naturally occurs) and a polynucleotide that exists as a separate molecule such as a polynucleotide produced by PCR amplification, chemical synthesis, restriction enzyme digestion, or in vitro transcription. An isolated polynucleotide is also a nucleic acid molecule, such as a recombinant nucleic acid molecule that forms part of hybrid polynucleotide encoding additional polypeptide sequences that can be used for example, in the production of a fusion protein.

Degenerate nucleotide sequences encoding polypeptides of the invention, as well as homologous variant nucleotide sequences that are at least about 75, or about 90, 96, 98, or 99% identical to the nucleotide sequences shown in the polynucleotide SEQ IDs and the complements thereof are also included in the invention. Percent sequence identity can be calculated as described in the “Polypeptides” section. Degenerate nucleotide sequences are polynucleotides that encode a polypeptide shown in the polypeptide SEQ IDs or fragments thereof, but differ in nucleic acid sequence from the sequence given in the polynucleotide SEQ IDs or nucleic acid sequences occurring in nature, due to the degeneracy of the genetic code. Complementary DNA (cDNA) molecules of polynucleotides that encode biologically functional polypeptides also are polynucleotides. A polynucleotide of the invention can comprise about at least 5, 10, 15, 50, 100, 200, 250, 300, 400, 500, or 600 contiguous nucleotides of a nucleic acid sequence shown in SEQ ID NOs:1-2.

Polynucleotides of the invention can be isolated from nucleic acid sequences present in, for example, a biological sample, such as a plant selected from, for example, the group consisting of algae, bryophytes, tracheophytes and angiosperms. The biological sample can also be a plant tissue, such as a plant tissue selected from the group consisting of a leaf, root, stem, flower, seed, and fruit. Polynucleotides can also be synthesized in the laboratory, for example, using an automatic synthesizer. An amplification method such as PCR can be used to amplify polynucleotides from either genomic DNA or cDNA encoding the polypeptides.

A polynucleotide can also comprise one or more expression control sequences such as promoters, origins of replication, or enhancers, for example. A polynucleotide of the invention can be present in a vector, such as, for example, an expression vector. If desired, polynucleotides can be cloned into an expression vector comprising, for example, origins of replication, promoters, enhancers, or other expression control sequences that drive expression of the polynucleotides of the invention in host cells. The polynucleotides can be operably linked to the expression control sequences, linked such that the expression control sequences drive expression of the polynucleotides. An expression vector can be, for example, a plasmid, such as pBR322, pUC, or ColE1, or an adenovirus vector, such as an adenovirus Type 2 vector or Type 5 vector. Optionally, other vectors can be used, including but not limited to Sindbis virus, simian virus 40, alphavirus vectors, poxvirus vectors, and cytomegalovirus and retroviral vectors, such as murine sarcoma virus, mouse mammary tumor virus, Moloney murine leukemia virus, and Rous sarcoma virus. Vectors suitable for use in the present invention include, for example, bacterial vectors, mammalian vectors, viral vectors (such as retroviral, adenoviral, adeno-associated viral, herpes virus, simian virus 40 (SV40), and bovine papilloma virus vectors) and baculovirus-derived vectors for use in insect cells. Minichromosomes such as MC and MC1, bacteriophages, phagemids, yeast artificial chromosomes, bacterial artificial chromosomes, virus particles, virus-like particles, cosmids (plasmids into which phage lambda cos sites have been inserted) and replicons (genetic elements that are capable of replication under their own control in a cell) can also be used. Polynucleotides in such vectors can be operably linked to a promoter, which is selected based on, e.g., the cell type in which expression is sought. Methods for preparing polynucleotides operably linked to an expression control sequence and expressing them in a host cell are well-known in the art. See, e.g., U.S. Pat. No. 4,366,246.

Host cells into which vectors, such as expression vectors, comprising polynucleotides of the invention can be introduced include, for example, prokaryotic cells (e.g., bacterial cells) and eukaryotic cells (e.g., yeast cells; insect cells; and mammalian cells). Such host cells are available from a number of different sources that are known to those skilled in the art, e.g., the American Type Culture Collection (ATCC), Rockville, Md. Host cells into which the polynucleotides of the invention have been introduced, as well as their progeny, even if not identical to the parental cells, due to mutations, are included in the invention.

Methods for introducing polynucleotides of the invention (e.g., vectors comprising the polynucleotides or naked polynucleotides) into cells (e.g., bacterial, yeast, insect or mammalian cells), either transiently or stably, are well known in the art. For example, transformation methods using standard CaCl₂, MgCl₂, or RbCl methods, protoplast fusion methods or transfection of naked or encapsulated nucleic acids using calcium phosphate precipitation, cellular fusion, microinjection, viral infection, and electroporation.

Isolation and purification of polypeptides produced in the systems described above can be carried out using conventional methods, appropriate for the particular system. For example, preparative chromatography and immunological separations employing antibodies, such as monoclonal or polyclonal antibodies, can be used.

Polynucleotides can be synthesized in the laboratory, for example, using an automatic synthesizer. An amplification method such as PCR can be used to amplify polynucleotides from either genomic DNA or cDNA encoding the polypeptides.

### Antibodies

Antibodies, such as monoclonal and polyclonal antibodies, antibody fragments, and single-chain antibodies that specifically bind to polypeptides of the invention are also part of the invention. An antibody and antigen (e.g., a polypeptide or polypeptide fragment of the invention) specifically bind to each other if they bind to each other with greater affinity than to other, non-specific molecules. For example, an antibody raised against an antigen to which it binds more efficiently than to a non-specific protein can be described as specifically binding to the antigen.

An antibody is said to be “directed against” a molecule if it is capable of specifically reacting with the molecule and specifically binding the molecule. An epitope refers to that portion of any molecule capable of being bound by an antibody which can also be recognized by that antibody. Epitopes or “antigenic determinants” usually consist of chemically active surface groupings of molecules such as amino acids or sugar side chains and have specific three-dimensional structural characteristics as well as specific charge characteristics.

Polypeptides of the invention comprise at least one epitope. An epitope is an antigenic determinant of a polypeptide. Epitopes within a polypeptide of the invention can be identified by several methods. See, e.g., U.S. Pat. No. 4,554,101; Jameson & Wolf, CABIOS 4:181-186 (1988) and “Polypeptide” section above.

An antibody is an intact immunoglobulin molecule, a fragment of an immunoglobulin molecule, or a single-chain antibody that specifically binds to a polypeptide of the invention (e.g., SEQ ID NOs:3-4 and/or fragments thereof). An antibody of the invention can be any antibody class, including for example, IgG, IgM, IgA, IgD and IgE.

Antibodies of the invention can be chimeric (see, e.g., U.S. Pat. No. 5,482,856), humanized (see, e.g., Jones et al., Nature 321:522 (1986); Reichmann et al., Nature 332:323 (1988); Presta, Curr. Op. Struct. Biol. 2:593 (1992)), or human antibodies. Human antibodies can be made by, for example, direct immortilization, phage display, transgenic mice, or a Trimera methodology, see e.g., Reisener et al., Trends Biotechnol. 16:242-246 (1998).

Antibody fragments of the invention retain some ability to selectively bind to the antigen (e.g., a polypeptide of the invention) from which they are derived, and can be made using well known methods in the art. In one embodiment of the invention, an antibody, antibody fragment or single-chain antibody comprises all such antibodies that specifically bind to a polypeptide of the invention (e.g., SEQ ID NOs:3-4 and/or fragments thereof). Fragments of antibodies are a portion of an intact antibody comprising the antigen binding site or variable region of an intact antibody, wherein the portion is free of the constant heavy chain domains of the Fc region of the intact antibody. Examples of antibody fragments include Fab, Fab′, Fab′-SH and F(ab′)₂ fragments.

Antigens that can be used in producing antibodies of the invention include polypeptides and polypeptide fragments of the invention. Antibodies of the invention can be made, for example, by using a polypeptide or a polypeptide fragment that contains an epitope present in a polypeptide shown in SEQ ID NOs:3-4 as an immunogen in standard antibody production methods (see e.g., Kohler et al., Nature, 256:495, 1975; Ausubel et al. (1992) Current Protocols in Molecular Biology, John Wylie and Sons, Inc. New York, N.Y.; Harlow and Lane, Eds, (1988) Current Edition, Antibodies: A Laboratory Manual, Cold Spring Harbor Press, N.Y). A polypeptide used to immunize an animal can be obtained by standard recombinant, chemical synthetic, or purification methods. As is well known in the art, in order to increase immunogenicity, an antigen can be conjugated to a carrier protein. Commonly used carriers include keyhole limpet hemocyanin (KLH), thyroglobulin, bovine serum albumin (BSA), and tetanus toxoid. The coupled peptide is then used to immunize an animal (e.g., a mouse, a rat, or a rabbit). In addition to such carriers, well known adjuvants can be administered with the antigen to facilitate induction of a strong immune response.

An antibody can be made in vivo in suitable laboratory animals or in vitro using recombinant DNA techniques. Means for preparing and characterizing antibodies are well know in the art. See, e.g., Dean, Methods Mol. Biol. 80:23-37 (1998); Dean, Methods Mol. Biol. 32:361-79 (1994); Baileg, Methods Mol. Biol. 32:381-88 (1994); Gullick, Methods Mol. Biol. 32:389-99 (1994); Drenckhahn et al. Methods Cell. Biol. 37:7-56 (1993); Morrison, Ann. Rev. Immunol. 10:239-65 (1992); Wright et al. Crit. Rev. Immunol. 12:125-68 (1992). For example, polyclonal antibodies can be produced by administering a polypeptide of the invention to an animal, such as a human or other primate, mouse, rat, rabbit, guinea pig, goat, pig, cow, sheep, donkey, or horse. Serum from the immunized animal is collected and the antibodies are purified from the plasma by, for example, precipitation with ammonium sulfate, followed by chromatography, such as affinity chromatography. Techniques for producing and processing polyclonal antibodies are known in the art.

Monoclonal antibodies directed against epitopes present on a polypeptide of the invention can also be readily produced. For example, normal B cells from a mammal, such as a mouse, which was immunized with a polypeptide of the invention can be fused with, for example, HAT-sensitive mouse myeloma cells to produce hybridomas. Hybridomas producing microbe-specific antibodies, such as Xanthomonas-specific antibodies, can be identified using RIA or ELISA and isolated by cloning in semi-solid agar or by limiting dilution. Clones producing microbe-specific antibodies are isolated by another round of screening. Monoclonal antibodies can be screened for specificity using standard techniques, for example, by binding a polypeptide of the invention to a microtiter plate and measuring binding of the monoclonal antibody by an ELISA assay. Techniques for producing and processing monoclonal antibodies are known in the art. See e.g., Kohler & Milstein, Nature, 256:495 (1975). Particular isotypes of a monoclonal antibody can be prepared directly, by selecting from the initial fusion, or prepared secondarily, from a parental hybridoma secreting a monoclonal antibody of a different isotype by using a sib selection technique to isolate class-switch variants. See Steplewski et al., P.N.A.S. U.S.A. 82:8653 1985; Spria et al., J. Immunolog. Meth. 74:307, 1984. Monoclonal antibodies of the invention can also be recombinant monoclonal antibodies. See, e.g., U.S. Pat. No. 4,474,893; U.S. Pat. No. 4,816,567. Antibodies of the invention can also be chemically constructed. See, e.g., U.S. Pat. No. 4,676,980.

Polyclonal and monoclonal antibodies can be purified, for example, by binding to, and elution from, a matrix containing a polypeptide or polypeptide fragment of the invention to which the antibodies were raised. Additional methods for antibody purification and concentration are well known in the art and can be practiced with the antibodies of the invention. Anti-idiotype antibodies corresponding to polypeptides of the invention are also included in the invention, and can be produced using standard methods.

Antibodies, antibody fragments, and single-chain antibodies of the invention can further be used to isolate microbes or microbial antigens, such as from Xanthomonas, by immunoaffinity columns. The antibodies can be affixed to a solid support by, for example, adsorption or by covalent linkage so that the antibodies retain their immunoselective activity. Optionally, spacer groups can be included so that the antigen binding site of the antibody remains accessible. The immobilized antibodies can then be used to bind microbes or microbial antigens from a biological sample, such as a plant selected from, for example, the group consisting of algae, bryophytes, tracheophytes and angiosperms. The biological sample can also be a plant tissue, such as a plant tissue selected from the group consisting of a leaf, root, stem, flower, seed, and fruit. The bound microbe or microbial antigens are recovered from the column matrix by, for example, a change in pH.

Antibodies of the invention can also be used in immunolocalization studies to analyze the presence and distribution of a polypeptide of the invention during various cellular events or physiological conditions. Identification of such molecules can be useful in vaccine development. Antibodies of the invention, including, for example, monoclonal antibodies and single-chain antibodies, can be used to monitor the course of amelioration of a disease caused by a microbe, such as Xanthomonas. By measuring the increase or decrease of microbial proteins in a test sample from a subject, such as a plant, using antibodies specific from microbes or microbial proteins, it can be determined whether a particular regimen aimed at ameliorating the disorder or disease is effective. Antibodies can be detected and/or quantified using for example, direct binding assays such as RIA, ELISA, or western blot assays.

### Aptamers of the Invention

An aptamer is a nucleic acid molecule (e.g., DNA or RNA or analogs thereof) that is capable of binding to a particular target molecule (e.g., a protein or polypeptide) with high affinity and specificity. See e.g., Tuerk and Gold, Science 249:505 (1990), Ellington and Szostak, Nature, 346:818 (1990).

Aptamers can bind protein targets and disrupt the interactions of the protein target with other proteins and/or disrupt catalysis by the protein targets. See e.g., Blind et al., Proc. Natl. Acad. Sci., 96:3606-3610 (1999); U.S. Pat. No. 5,756,291; U.S. Pat. No. 5,840,867; Osborne et al., Curr. Opin. Chem. Biol. 1:5-9 (1997).

Aptamers of the invention have specific binding regions that form complexes with a polypeptide, such as the polypeptides shown in SEQ ID NOs:3-4 and/or fragments thereof under conditions where other non-specific substances are not complexed with the aptamer. Aptamers of the invention can also complex with a protein, such as a protein comprising SEQ ID NOs:3-4 and/or fragments thereof under conditions where other non-specific substances are not complexed with the aptamer. The specificity of binding is defined in terms of comparative dissociation constants (Kd) of an aptamer for its ligand (in this case SEQ ID NOs:3-4 and/or fragments thereof) as compared to the dissociation constant of the aptamer for other non-specific substances. Typically, the Kd of an aptamer for its ligand is about 10-fold less that the Kd for the aptamer for non-specific substances. In other embodiments, the Kd is about 50-fold, 100-fold, or 200-fold less that the Kd for the aptamer for non-specific substances. An aptamer can be, for example, 10, 20, 50, 100, 150, 200, 300, 400, or 500 nucleotides in length.

Aptamers can be identified for a specific polypeptide or protein target using for, example, selective evolution of ligands by exponential enrichment (SELEX) methods. See e.g., Wilson and Szoztak, Ann. Rev. Biochem. 68:611-647 (1999); Sun, Curr. Opin. Mol. Ther. 2:100-5 (2000); U.S. Pat. No. 5,861,254; U.S. Pat. No. 5,475,096; U.S. Pat. No. 5,595,877; U.S. Pat. No. 5,660,985; see also, U.S. Pat. No. 6,180,348; Bock et al., Nature, 355:564-566 (1990); Conrad et al., Methods in Enzymol., 267:336-367 (1996).

### Methods of Diagnosis of Microbial Infection and Detection of Microbe

Antibodies, antibody fragments, single-chain antibodies, polypeptides and polynucleotides of the invention can be used to detect microbes, microbial polynucleotides, and microbial polypeptides in a test sample, such as a biological sample.

A biological sample can be, for example, a plant, such as a plant selected from the group consisting of algae, bryophytes, tracheophytes and angiosperms. The biological sample can also be a plant tissue, such as a plant tissue selected from the group consisting of a leaf, root, stem, flower, seed, and fruit.

An antibody, antibody fragment, or single-chain antibody of the invention can be used to detect microbial infection, the presence of microbial polypeptides or fragments thereof, and/or microbes by contacting a test sample suspected of containing a microbial polypeptide, fragment thereof, or microbes (i.e., antigens) with an antibody of the invention under conditions enabling the formation of an antibody-antigen complex (i.e., an immunocomplex). The amount of antibody-antigen complexes can be determined by methodology known in the art. A level that is higher than that formed in a control sample indicates a microbial infection and/or the presence of a microbial polypeptide, fragment thereof, and/or microbes in the test sample.

Methods of detection of an antigen in test sample using an antibody, antibody fragment, or single-chain antibody are well known in the art and any such method can be used. Antibodies of the invention can be used in vitro or in vivo for immunodiagnosis. The antibodies are suited for use in, for example, immunoassays in which they are in liquid phase or bound to a solid phase carrier. Antibodies, fragments thereof, and/or single-chain antibodies of the invention can be bound to a support and used to detect the presence of microbes or microbial antigen. Supports include, for example, glass, polystyrene, polypropylene, polyethylene, dextran, nylon, amylases, natural and modified celluloses, polyacrylamides, agaroses and magletite.

The antibodies used in such immunoassays can be detectably labeled (e.g., with an enzyme, a radioisotope, a fluorescent compound, a colloidal metal, a chemiluminescent compound, a phosphorescent compound, or a bioluminescent compound) using any of several standard methods that are well known in the art. Alternatively, the antibodies can be unlabeled. Examples of immunoassays in which the antibodies of the invention can be used include, e.g., competitive and non-competitive immunoassays, which are carried out using either direct or indirect formats. Examples of such immunoassays include radioimmunoassays (RIA) and sandwich assays (e.g., enzyme-linked immunosorbent assays (ELISAs)). Detection of microbial polypeptides using antibodies of the invention can be done using immunoassays that are run in either forward, reverse, or simultaneous modes, including immunohistochemical assays on physiological samples. Other immunoassay formats are well known in the art, and can be used in the invention.

An immunoassay can utilize one antibody or several antibodies. An immunoassay can use, for example, a monoclonal antibody directed towards a microbial epitope, a combination of monoclonal antibodies directed towards epitopes of one microbial polypeptide, monoclonal antibodies directed towards epitopes of different microbial polypeptides, polyclonal antibodies directed towards the same microbial antigen, polyclonal antibodies directed towards different microbial antigens, or a combination of monoclonal and polyclonal antibodies.

An antibody of the invention can be used in a method of the diagnosis of microbial infection by obtaining a test sample from a biological subject, such as a plant, suspected of having a microbial infection. The test sample is contacted with an antibody of the invention under conditions enabling the formation of an antibody-antigen complex (i.e., an immunocomplex). The presence and/or amount of antibody-antigen complexes can be determined by methodology known in the art. The presence of complexes and/or a level of complexes that is higher than that formed in a control sample indicates a microbial infection.

One embodiment of the invention provides methods of detecting the presence of a microbe or microbial polypeptide in a test sample. The methods comprise contacting a test sample with an antibody, antibody fragment, or single-chain antibody of the invention that specifically binds a microbe or microbial polypeptide under conditions that allow formation of an immunocomplex between the antibody, antibody fragment, or single-chain antibody and the a microbe or microbial polypeptide. Detection of an immunocomplex indicates the presence of a microbe or microbial polypeptide in the test sample. The detected a microbial polypeptide can be expressed in vivo during infection of a biological sample, such as a plant.

Another embodiment of the invention provides methods for detecting microbes in a subject. The methods comprise obtaining a biological sample from the subject and contacting the biological sample with an antibody, antibody fragment, or single-chain antibody of the invention under conditions that allow formation of immunocomplexes between the antibody, antibody fragment, or single-chain antibody and microbial polypeptides present in the biological sample. Immunocomplexes are detected. The detection of immunocomplexes indicates a microbial infection in the subject. Alternatively or additionally the amount of immunocomplexes is detected. The amount of immunocomplexes formed is compared to a control sample. A higher amount of immunocomplexes in the biological sample than in the control sample indicates a microbial infection in the subject.

Polynucleotides and fragments thereof the invention can be used, for example, as probes or primers, for example PCR primers, to detect the presence of microbial polynucleotides in a test sample, such as a biological sample. The ability of such probes and primers to specifically hybridize to microbial polynucleotide sequences will enable them to be of use in detecting the presence of complementary sequences in a given sample. Polynucleotides from the sample can be, for example, subjected to gel electrophoresis or other size separation techniques or can be immobilized without size separation. The polynucleotide probes or primers can be labeled or unlabeled. Suitable labels, and methods for labeling probes and primers are known in the art, and include, for example, radioactive labels incorporated by nick translation or by kinase, biotin labels, fluorescent labels, chemiluminescent labels, bioluminescent labels, metal chelator labels and enzyme labels. The polynucleotides from the sample are contacted with the probes or primers under hybridization conditions of suitable stringencies.

One embodiment of the invention provides methods of detecting the presence of a first microbial polynucleotide in a test sample. The methods comprise contacting a test sample suspected of containing the first polynucleotide with a second polynucleotide under hybridization conditions. The second polynucleotide is an isolated polynucleotide comprising a sequence that encodes an isolated immunogenic polypeptide comprising about at least 5 contiguous amino acids of an amino acid sequence selected from the group consisting of SEQ ID NOs:3-4. A hybridized first and second polynucleotide complex is detected. The presence of a hybridized first and second polynucleotide complex indicates the presence of a first polynucleotide in the test sample.

One embodiment of the invention provides methods for detecting a microbe in a subject. The methods comprise obtaining a biological sample from the subject and contacting the biological sample with the polynucleotide of the invention under conditions that allow the formation of a hybridized complex between the polynucleotide of the invention and microbial polynucleotides present in the biological sample. The amount of hybridized complexes are detected and optionally compared to a control sample. The presence of hybridized complexes or a higher amount of hybridized complexes in the biological sample than in the control sample indicates a microbial infection in the subject.

Depending on the application, varying conditions of hybridization can be used to achieve varying degrees of selectivity of the probe or primer towards the target sequence. For applications requiring high selectivity, relatively stringent conditions can be used, such as low salt and/or high temperature conditions, such as provided by a salt concentration of from about 0.02 M to about 0.15 M salt at temperatures of from about 50° C. to about 70° C. For applications requiring less selectivity, less stringent hybridization conditions can be used. For example, salt conditions from about 0.14 M to about 0.9M salt, at temperatures ranging form about 20° C. to about 55° C. The presence of a hybridized complex comprising the probe or primer and a complementary polynucleotide from the test sample indicates the presence of a microbe or a microbial polynucleotide sequence in the sample.

The materials for use in a detection method of the invention can be present in a kit. A kit can comprise one or more elements used in the method. For example, a kit can contain one or more antibodies, antibody fragments, single-chain antibodies, polypeptides, or polynucleotides of the invention in one or more containers. The kit and container or containers are labeled with their contents and the kit includes instructions for use of the elements in the containers. The constituents of the kit can be present in, for example, liquid or lypholized form.

### Methods of Treatment and Prevention

Diseases and symptoms in a subject caused by a microbe can be treated and/or prevented in a subject by, for example, administration to a subject with polynucleotides and/or polypeptides and/or aptamers of the invention. Alternatively, the disease or symptom can be treated or prevented by a biological agent of the invention.

As used herein, a “biological agent” includes natural or synthetic products, microorganisms, plant extracts and chemicals. For the purposes of this invention, beneficial or desired results include, but are not limited to, alleviation of symptoms, diminishment of extent of infection, stabilized (i.e. not worsening) state of infection, prevention of spread of infection, delay or slowing of infection progression, amelioration or palliation of the infection.

The biological agents of the present invention include biological agents that are effective in controlling plant diseases that can damage paddy field crops, upland crops, fruit trees, vegetables, other crops, such as bean, potatoes, vines, hops, maize, sugar beet, tobacco, vegetables (tomatoes, paprika, lettuce, etc.), and also bananas, natural rubber plants; flowers and ornamental plants, and the like. For example, the biological agents of the present invention can treat the plant disease of bean blight. Therefore, the desired effects of the biological agents of the present invention can be obtained by applying the biological agents to the paddy field water, stalks and leaves of fruit trees, vegetables, other crops, flowers and ornamental plants, soil, etc., at a season at which the diseases are expected to occur, before their occurrence or at the time when their occurrence is confirmed.

In general, the biological agent of the present invention is used after being prepared into a conveniently usable form according to an ordinary manner for preparation of agrochemicals. That is, the biological agent according to the present invention and, optionally, an adjuvant are blended with a suitable inert carrier in a proper proportion and prepared into a suitable preparation form such as a suspension, emulsifiable concentrate, soluble concentrate, wettable powder, granules, dust or tablets through dissolution, dispersion, suspension, mixing, impregnation, adsorption or sticking.

The inert carrier used in the present invention may be either solid or liquid. As the solid carrier, there can be exemplified soybean flour, cereal flour, wood flour, bark flour, saw dust, powdered tobacco stalks, powdered walnut shells, bran, powdered cellulose, extraction residue of vegetables, powdered synthetic polymers or resins, clays (e.g. kaolin, bentonite, and acid clay), talcs (e.g. talc and pyrophyllite), silica powders or flakes (e.g. diatomaceous earth, silica sand, mica and white carbon, i.e. synthetic, high-dispersion silicic acid, also called finely divided hydrated silica or hydrated silicic acid, some of commercially available products contain calcium silicate as the major component), activated carbon, powdered sulfur, powdered pumice, calcined diatomaceous earth, ground brick, fly ash, sand, calcium carbonate powder, calcium phosphate powder and other inorganic or mineral powders, chemical fertilizers (e.g. ammonium sulfate, ammonium phosphate, ammonium nitrate, urea and ammonium chloride), and compost. These carriers may be used alone or as a mixture thereof.

The liquid carrier is that which itself has solubility or which is without such solubility but is capable of dispersing an active ingredient with the aid of an adjuvant. The following are typical examples of the liquid carrier and can be used alone or as a mixture thereof: water; alcohols, such as methanol, ethanol, isopropanol, butanol and ethylene glycol; ketones, such as acetone, methyl ethyl ketone, methyl isobutyl ketone, diisobutyl ketone and cyclohexanone; ethers, such as ethyl ether, dioxane, Cellosolve, dipropyl ether and tetrahydrofuran; aliphatic hydrocarbons such as kerosene and mineral oils; aromatic hydrocarbons such as benzene, toluene, xylene, solvent naphtha and alkylnaphthalenes; halogenated hydrocarbons such as dichloroethane, chloroform, carbon tetrachloride and chlorobenzene; esters such as ethyl acetate, diisopropyl phthalate, dibutyl phthalate and dioctyl phthalate; amides such as di-methylformamide, diethylformamide and dimethylacetamide; nitriles such as acetonitrile; and dimethyl sulfoxide.

The following are typical examples of the adjuvant, which are used depending upon purposes and used alone or in combination in some cases, or need not to be used at all. To emulsify, disperse, dissolve and/or wet an active ingredient, a surfactant is used. As the surfactant, there can be exemplified polyoxyethylene alkyl ethers, polyoxyethylene alkylaryl ethers, polyoxyethylene higher fatty acid esters, polyoxyethylene resinates, polyoxyethylene sorbitan monolaurate, polyoxyethylene sorbitan monooleate, alkylarylsulfonates, naphthalenesulfonic acid condensation products, ligninsulfonates and higher alcohol sulfate esters. Further, to stabilize the dispersion of an active ingredient, tackify it and/or bind it, there may be used adjuvants such as casein, gelatin, starch, methyl cellulose, carboxymethyl cellulose, gum arabic, polyvinyl alcohols, turpentine, bran oil, bentonite and ligninsulfonates. To improve the flowability of a solid product, there may be used adjuvants such as waxes, stearates and alkyl phosphates. Adjuvants such as naphthalenesulfonic acid condensation products and polycondensates of phosphates may be used as a peptizer for dispersible products. Adjuvants such as silicon oils may also be used as a defoaming agent.

The content of the active ingredient may be varied as required. In dusts or granules, the suitable content thereof can be from 0.01 to 50% by weight. In emulsifiable concentrates or flowable wettable powders, it can also be from 0.01 to 50% by weight.

The present inventive biological agents are used to control various diseases in various manners. It can be applied to a crop on which the diseases are expected to occur, or a site where the occurrence of the diseases is undesirable, as it is or after being properly diluted with or suspended in water or the like, in an amount effective for control of the diseases.

The applying dosage of the biological agents of the present invention vary depending upon various factors such as a purpose, diseases to be controlled, a growth state of a plant, tendency of disease occurrence, weather, environmental conditions, a preparation form, an application method, an application site and application time. It may be properly chosen in the range of 0.1 g to 10 kg (in terms of the active ingredient) per 10 ares depending upon purposes. The present inventive biological agents may be used in admixture with other agricultural and horticultural disease controllers in order to expand both spectrum of controllable diseases and the period of time when effective applications are possible or to reduce the dosage.

For agricultural uses, the biological agents identified using the methods disclosed herein may be used as chemicals applied as sprays or dusts on the foliage of plants. Typically, such agents are to be administered on the surface of the plant in advance of the pathogen in order to prevent infection. Seeds, bulbs, roots, tubers, and corns are also treated to prevent pathogenic attack after planting by controlling pathogens carried on them or existing in the soil at the planting site. Soil to be planted with vegetables, ornamentals, shrubs, or trees can also be treated with chemical fumigants for control of a variety of microbial pathogens. Treatment is preferably done several days or weeks before planting. The chemicals can be applied by either a mechanized route, e.g., a tractor or with hand applications. In addition, chemicals identified using the methods of the assay can be used as disinfectants.

All patents, patent applications, and other scientific or technical writings referred to anywhere herein are incorporated by reference in their entirety. The invention illustratively described herein suitably can be practiced in the absence of any element or elements, limitation or limitations that are not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments, optional features, modification and variation of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

The following are provided for exemplification purposes only and are not intended to limit the scope of the invention described in broad terms above.

### Example 1

In one embodiment of the invention a plant tissue that is infected with a bacterium is used to immunize an animal. Antibodies are collected from the immunized animal and are adsorbed with extracts of the bacteria grown in vitro.

An adsorption is performed, for example, using both whole cells and cell extracts immobilized on a solid support, such as nitrocellulose. Antibodies are subjected to multiple successive adsorptions. Each adsorption consists of, for example, an overnight incubation of the antibodies with approximately 10¹¹ bacteria in 100 μl of phosphate buffered saline (PBS, pH 7.2) containing 0.02% sodium azide with mild agitation at 4° C. The antibodies are further adsorbed by, for example, incubation overnight at 4° C. with a nitrocellulose membrane (10 cm diameter) or latex beads saturated with bacterial extracts prepared by French-press treatment of 10¹¹ in vitro grown bacteria cells. A final adsorption step can be carried out using, for example, the same extract that has been heat denatured in a boiling water bath (10 min.) before immobilization on nitrocellulose or latex beads in order to expose additional immunoreactive epitopes.

### Example 2

### Expression Library Construction And Screening

Genomic expression libraries of the bacteria in pET30a, pET30b or pET30c are prepared, for example, in E. coli strain BL21 (DE3) (Novagen, Madison, Wis.). Briefly, as an example, genomic DNA purified from the bacteria is partially digested with a restriction enzyme, such as sau3A, chosen to optimize the production of 0.5 to 1.5 kb fragments that are purified by agarose gel electrophoresis. The fragments are ligated into the multiple cloning site of pET30a inducible expression system (Novagen; Madison, Wis.) that had been digested with BamHI, dephosphorylated with calf intestinal phosphatase (New England Biolabs, Beverly, Mass.), and then transformed into Escherichia coli strain BL21 (DE3) (Novagen). Similar libraries are also constructed with, for example, pET30b and pET30c.

The resulting bacterial genomic expression library is serially diluted and plated on brain-heart infusion (BHI) medium containing kanamycin (50 μg/ml) to generate plates containing approximately 500 colonies per plate. These colonies are replicated using sterile velvet onto duplicate BHI plates containing kanamycin and IPTG (1 mM) and incubated for 5 hours at 37° C. to induce expression of the cloned polynucleotides. To lyse the bacteria, for example, the colonies are exposed to chloroform vapors for 15 min. and overlaid with nitrocellulose membranes for 15 min. at room temperature. The membranes are carefully removed and blocked with 5% non-fat skim-milk solution in PBS at pH 7.2 containing 0.5% Tween-20 (PBS-Tween™). The colonies are first probed with a 1:10,000 dilution of unadsorbed antibodies overnight at 4° C. and then with a 1:20,000 dilution of peroxidase conjugated goat anti-human IgG. Reactive colonies are detected using the ECL kit and Hyperfilm™ ECL (Amersham Pharmacia Biotech, Piscataway N.J.). X-ray film exposure times are adjusted to optimize signal to noise.

Potential bias created by using a single restriction enzyme is eliminated by, for example, using a second restriction enzyme, DNA sheared by a HydroShear™ apparatus (GeneMachines, San Carlos Calif.), or sonically sheared DNA to create a second, independent expression library in, for example, pET30abc. In the latter case, purified bacterial DNA at a concentration of approximately 1 μg/μl is treated on ice with 3 second resonance frequency bursts of sonication using a Microson Ultrasonic Cell Distruptor (Heat Systems-Ultrasonics, Inc.). Samples taken at each time point are analyzed by agarose gel electrophoresis to determine the conditions required to optimize production of 0.75 to 1.5 Kb fragments. These conditions are employed to generate sufficient starting material for library construction. Terminal overhangs are removed, for example, with Klenow and dNTPs and the resulting blunt end products are ligated into the dephosphorylated EcoRV restriction site in the pET30a, pET30b, or pET30c multiple cloning site. The vector library is then transformed into E. coli host strain, BL21 (DE3), with clones selected on BHI/kanamycin medium as previously described. Plates containing appropriate numbers of colonies are probed with the unadsorbed antibodies and reactive colonies are detected using peroxidase-labeled immunoglobulin. Reactive colonies are isolated and their vector DNA purified.

The cloned inserts are sequenced in both directions. MacVector v.6.0.1 is used to identify open reading frames using both Fickett's and start/stop codon methods. Where more than one open reading frame is present on a cloned insert, the reading frame that is most likely to be the one encoding the antigen reactive with the unadsorbed antibodies is determined, for example, using a colony lift method. The colony lift method is used to determine if the level of expression of the antigen is regulated by IPTG. Briefly, each clone is grown overnight at 37° C. in BHI broth containing kanamycin, the cells concentrated 200-fold, and 1 μl of each culture is spotted on BHI agar plates containing kanamycin with or without IPTG. Following incubation of the plates at 37° C. for five hours, the colonies are partially lysed with chloroform vapors, lifted onto nitrocellulose membranes, and reacted with the unadsorbed antibodies. Two negative controls can be included in this IPTG induction assay, namely pET30a/BL21 (DE3) with no cloned insert and a randomly selected clone that contains a cloned DNA insert, but is non-reactive with the unadsorbed antibodies.

Clones that express immunoreactive proteins induced by IPTG likely have their open reading frames cloned in the same orientation as the endogenous pET30 promoter. Their translation is either initiated at the pET30 ribosome binding site or at their own ribosome binding site. Open reading frames found in the IPTG inducible clones are further examined by individually amplifying the open reading frames by PCR and subcloning the frames so that they are in-frame and under control of the pET30EkLIC (Novagen, Madison, Wis.) IPTG-regulated promoter. Reactivity with the unadsorbed antibodies and IPTG inducibility of these subclones is confirmed using the colony lift method described previously.

### Verification of Specific In Vivo Expression

It is possible to directly verify that in vivo induced antigens identified by methods of the invention are actually expressed by a microbe when it is growing at the site of infection in the host. This is accomplished with a method that directly probes biological specimens taken from disease sites of infected hosts. The first step in this process optimizes the recombinant protein production by the subclones obtained in the previous step. Samples of a culture are removed at hourly intervals and analyzed by SDS-PAGE to determine the incubation time required for maximum production of the cloned protein. Inclusion body preparations (Harlow & Lowes Eds., Antibodies, a Laboratory Manual, (CSHL Press, Plainview, N.Y., 1988)) are made from 10 ml batch cultures of a subclone and incubated for 3 hours with IPTG. SDS-PAGE and Western blot analysis are performed to confirm that the overexpressed protein is reactive with the unadsorbed antibodies used in an original screening. A reactive band is excised from the Coomassie stained gel and used to raise polyclonal antibodies in mice.

Three female Balb/C mice are used per antigen. The 6-8 week old mice are injected subcutaneously (sc) with the purified polypeptide, using a concentration of 20 μg/mouse. Alternatively, a concentration of 50 or 100 μg/mouse can be used. RIBI MPL+TDM emulsion are used as an adjuvant. Two weeks later, the immunization protocol are repeated. Approximately 10 days after the second immunization, a small amount of blood is taken from the tail vein of each mouse, and assayed by ELISA to evaluate the response to the immunogen. When the mice are responding well (i.e., detection at serum dilution greater than 1:500), one more sc injection are given 3-4 weeks after the second immunization, and four days before a scheduled hybridoma fusion. A mouse myloma cell line (Sp2/0) is cultured for several days prior to the scheduled fusion. Log phase cells are counted and washed.

A mouse exhibiting the best serum titer is anesthetized and bled out. The spleen is removed. The blood is clotted and spun down and the serum saved to be used as a positive control in subsequent assays. The spleen cells are flushed out of the spleen capsule and separated into single cells, washed, and counted. Spleen cells are combined with Sp2/0 cells at a 7:1 ratio. Cells are pelleted by centrifugation. PEG 1500 at a concentration of 50% are slowly added to the cell pellet and then diluted. Cells are spun down and the pellet resuspended in HAT selective medium containing 20% horse serum and 25% conditioned media. Cells are plated into 96 well plates at a concentration of 2.5×10⁵ cells/well. Cells are grown in a 37° C. incubator with 7% atmospheric CO₂. After several days, colonies of hybridoma cells are usually visible. Feeding (removing and replacing approximately 50% of the total volume of growth medium) is performed at day seven and again at day nine or ten. When the hybridoma cells are nearly confluent in each well, a portion of the supernatant is removed and assayed by ELISA to detect the presence of the desired antibody. The cells in the wells that tested positive on the primary screen are transferred to a 24 well plate, and the supernatant tested again by ELISA. The antibody activity and preliminary heavy chain isotype of each mass culture is determined and the wells that scored positive during this secondary round of screening are transferred to 6-well plates. At this point, the cells are designated as mass cultures. Each mass culture chosen is cultured briefly in 6-well plate wells in order to freeze two vials of cells. Supernatant is saved for future expanded screening. The best mass cultures are selected for ascites production. Ascites are induced by intraperitoneal injection into one female Balb/C mouse, which is monitored daily for 7 days. The ascitic fluids are collected every day for 3 days (for a final volume of ca. 10 ml).

Ascites fluid are filtered and circulated over a protein A affinity column to affinity purify IgG. The polyclonal antibodies are washed and eluted with 0.1 M glycine, pH 3.0, followed by neutralization with Tris, pH 9-10. The recovered antibodies are concentrated, and the buffer exchanged to 1×PBS with 0.02% azide. The yield and quality of the antibodies is evaluated spectrophotometrically (280 nm) and by SDS-PAGE, respectively.

The purified IgG is tested for reaction in western blots with a protein of the appropriate size in extracts and inclusion body preparations made from the clone. The antibodies are labeled directly with, for example, fluorescein isothiocyanate (FITC) (Molecular Probes, Eugene, Oreg., USA). A murine monoclonal antibody specific for the bacteria, is labeled with, for example, Texas-red (TR).

Samples of bacterial infected host tissue and matched in vitro grown cells are assayed by immunofluorescence microscopy. Briefly, infected host tissue samples are homogenized by brief vortexing at 4° C., and immediately heat-fixed on microscope slides. Infected host tissue samples and matched in vitro grown bacterial isolates are probed in parallel with FITC-labeled monospecific antibody directed against the bacterial antigen and the TR-labeled monoclonal antibody specific for the bacteria. Samples are examined by fluorescence microscopy (excitation wavelength 488 nm). Double color analysis, using matched differential emission filters, is performed to identify individual cells that were simultaneously labeled with FITC and TR. Bacterial cells that react with the TR-labeled monoclonal antibody should also react with FITC-labeled antibody and these signals should co-localize. In contrast, matched in vitro grown bacteria should react with the TR-labeled monoclonal antibody, but not with the FITC-labeled antibody. These results provide direct evidence that the bacteria express an antigen exclusively during in vivo growth.

Each antibody is independently screened against all of the plant samples collected in order to optimize the identification of bacteria growing under environmental conditions appropriate for expression of the in vivo induced antigen. Bacteria-deficient samples are included to serve as an additional negative control for the species-specific antibody and to identify possible cross-reacting antigens presented by other species that are present in the plant. Of the three most likely outcomes, there will be instances where cells react with Texas red-labeled antibody and one or all of these cells also react with a FITC-labeled antibody. This indicates that the bacteria produce a particular antigen during growth in a site of infection. There is no requirement for all of the bacterial cells in a sample to react with the antibody since there are likely to be numerous microenvironments present at each sampling site. As a second possible outcome, there can be instances where none of the cells that react with the Texas red-labeled antibody also react with a particular FITC-labeled antibody. This indicates that none of the plant samples were taken from sites presenting the necessary environmental stimulus. Clearly, by using a large number of plant samples taken from plants in different stages of infection, this possibility is reduced. As another possible outcome of interest, plant samples can contain cells that react with a particular FITC-labeled antibody but that do not react with Texas red-labeled antibody. These are likely to represent instances where plant samples contain other bacterial species that produce a cross-reacting antigen. However, it is also possible that these cells belong to a strain or variant of the bacteria that does not react with the species antibody. In these instances, previous culturing data along with ribotyping verification help to distinguish between these possibilities.

Alternatively, antibodies are labeled with ferritin or gold particles and detected by immunoelectron microscopy.

As an alternative approach to the microscopy methods described above, FITC-labeled antibodies and a fluorescence-activated cell sorting system is used (e.g., FACSort, Becton Dickinson; Franklin Lanes, N.J.). Recent reports have demonstrated the technical feasibility of using automated cell sorters for separating bacteria (Valdivia & Falkow, Science, 277:2007 (1997); Handfield & Levesque, FEMS Microbiol. Rev. 23:69-91 (1999). In addition, FACS can be used to effectively separate specific bacteria from a mixed bacterial population using the green fluorescence protein (GFP) as a gene marker.

### Example 3

### Application of In Situ Induced Antigen Technology (ISIAT)

### Serum Generation

ISIAT was applied to the bean plant, Phaseolus vulgaris L., using the natural pathogen Xanthomonas campestris pv. phaseoli. Bean line Xan159 was infected with Xanthomonas strain LB-2 (see Andrus, C. F. (1948) Phytopathology 38: 757-759), and infected leaves harvested nine, eleven, fourteen, and sixteen days post-infection. Bean line Sel27 was infected with Xanthomonas strain DRS103 and harvested at nine, eleven and fourteen days in the same manner. Both bean lines are susceptible to infection by the utilized Xanthomonas strain. The harvested diseased leaves listed above were quick frozen on dry ice and stored at −80° C. until used to preserve proteins expressed by the pathogen and the host bean plant. Samples (ca. 2 cm²) of different infected leaf tissue were pooled and macerated in sterile phosphate-buffered saline (PBS) on ice. The resultant slurry was heat denatured and passed through a syringe before the addition of Ribi adjuvant prior to injection. Two adult female New Zealand white rabbits each received two intramuscular and two subcutaneous injections of antigenic material. The animals were boosted with the same protocol 28 and 53 days after the initial antigen presentation. Exsanguination by cardiac puncture was performed 68 days after the initiation of experimentation. Approximately 35 ml of serum was recovered from each animal, and frozen with 0.05% azide until subsequent use.

### Serum Adsorption

ELISA using French-press disrupted cell extracts of Xanthomonas LB-2 as target verified that the serum from each animal was approximately equal in reactivity. Samples of serum (1.5 ml) from each rabbit were pooled and adsorbed six times with in vitro-grown Xanthomonas LB-2 cells to eliminate antibodies binding to proteins made by LB-2 during in vitro cultivation. Serum was then adsorbed once with native or heat denatured French-pressed extracts of LB-2 immobilized on polystyrene beads. Serum was subsequently adsorbed against native or heat denatured French-pressed extracts of immobilized E. coli BL21 (DE3)/pET30b to remove antibodies reactive with the library host strain. Serum was then passed over a protein-A column (Biorad) to specifically recover IgG antibodies. Approximately 10¹¹ bacteria were used in the absorption step, which represented approximately 5 mg of cellular protein.

To evaluate the efficiency of the adsorption steps, French-press cell extracts of LB-2 grown in vitro were immobilized in microtiter wells (approximately 100 μl of 10¹¹ cells/ml) and following an ELISA procedure, were reacted with serial dilutions of serum samples taken at different points in the adsorption process. Successive adsorptions essentially removed all of the antibodies reactive with in vitro grown LB-2. This was further confirmed by Western blot analysis of the adsorbed serum reactivity against LB-2 grown in vitro. This adsorbed antibody preparation was used to probe the Xanthamonas genomic expression library described below.

In a similar fashion, another 3 ml of pooled sera from the rabbits was adsorbed with healthy, control bean plant leaf cells. A slurry was prepared by crushing approximately eight 2 cm² samples of sel127 and xan159 leaf tissue in 10 ml PBS using a mortar and pestle on ice. One ml of this slurry was used for each adsorption. The serum was also adsorbed with native and denatured extracts of the bean plant cells using French-press treated samples (approximately 5 mg) of the slurry described above, bound to the latex beads. Both native and heat-denatured extracts were used. ELISA and Western-blot analysis of the adsorbed serum using samples from successive adsorption steps confirmed that essentially all of the antibodies reactive with healthy bean plant cells had been removed. IgG was purified from the adsorbed serum and used to probe the bean plant genomic expression library described below.

### Library Construction and Screening

Genomic expression libraries of X campestris LB-2 in pET30b were prepared in E. coli strain BL21 (DE3). Briefly, approximately 10 mg of genomic DNA purified from strain LB-2 was hydrosheared, blunt-ended and gel purified to recover 0.5 to 1.5 kb fragments. The resultant blunt-end products were ligated into the dephosphorylated EcoRV restriction site in pET30b. The recombinant plasmid was transformed into BL21 (DE3), and the resultant LB-2 genomic expression library was diluted and spread on brain heart infusion (BHI) plates (50 μg/ml kanamycin) to yield approximately 500 colonies per plate. Colonies were transferred to nitrocellulose membranes by colony lift, and incubated on BHI/kanamycin plates containing 1 mM IPTG for three hours to induce expression of the cloned polynucleotides. Colony cells were lysed on the membrane by brief exposure to chloroform, blocked in 5% milk, and incubated overnight at 4° C. with a 1:5,000 dilution of the Xanthomonas-adsorbed antibody preparation described above. After washing, membranes were exposed to goat anti-rabbit IgG secondary antibody coupled with a peroxidase reporter (1:20,000 dilution from ICN/Capel). Reactive colonies were isolated, and re-screened three times to eliminate false positives. As an example, 25,000 LB-2 clones were screened; this yielded 82 clones for secondary analysis. Of these, five clones were identified for further analysis. A similar bean plant genomic expression library was constructed in BL21 (DE3)/pET30b and probed with the healthy bean plant cell-adsorbed antibody preparation described above. As an example, 25,000 bean plant clones were screened; this yielded 130 prospective clones for secondary analysis. Of these, 30 positive clones have been confirmed.

Characterization of Positive IVI Genes from Xanthamonas

Positive clones from the genomic screen of LB-2 were further investigated. DNA from these clones was isolated and sequenced. The resultant sequence data was used for genomic analysis, such as investigation of open reading frames and database homologies. IPTG-induced and uninduced clones were analyzed by SDS-PAGE as follows: overnight BHI broth/kanamycin cultures of the clones were subcultured in BHI broth/kanamycin with and without 1 mM IPTG. Samples of the induced and uninduced cultures of each clone were run on denaturing 12% polyacrylamide gels and stained with Coomassie Blue to observe over-production of the cloned reactive protein. Additionally, a replicate gel was analyzed by Western blot for reactivity to mouse anti-HIS peroxidase conjugated antibody. The pET-30b library vector contains a sequence that adds a HIS-tag to the terminus of the protein expressed from the cloned gene, and thus allows visualization of the tagged-protein complex. Furthermore, another replicate gel was probed with the adsorbed rabbit antibody preparation to confirm the identity of an in vivo induced (“IVI”) gene by serum reactivity against the expressed protein.

### IVI Genes of Xanthomonas

The expressed products of two X. campestris pv. phaseoli IVI genes (Table 1) isolated using the ISIAT screen have been shown to be IPTG-inducible, and specifically react with the Xanthomonas adsorbed serum and the anti-HIS-tag antibody. The two genes encode novel proteins (Table 1) that are homologous to hypothetical proteins previously found in the genomes of the related pathogens X. campestris pv. campestris (Xcc) and X. axonopodis pv. citri (Xac).

TABLE I

XcB2-29; Homology to Xac 4111, Xcc
4021 hypothetical proteins

SEQ ID NO: 1
ATGCACCATCATCATCATCATTCTTCTGGTCTGGTGCCACGCGGTTCTGG
TATGAAAGAAACCGCTGCTGCTAAATTCGAACGCCAGCACATGGACAGCC
CAGATCTGGGTACCGACGACGACGACAAGGCCATGGCGATCTACGCTGCA
CGCCCAGGGCACACCGCGCCAGCGCATACTGCCCGGCGATCAATCCGGAT
AACGACAATGAACAAAGCACGTCTTCTGCTACTGCCGTTACTGTTGCTCG
GCGGCTGTGCCACCAGCGGCGGCGACCGCGCCGGTGGCGATATCCCGGCT
GGCGCCGATGTCACCAGCAAGACCATGGGCAATGGCGACAAGGTCGACGA
ATACCGCGTCAACGGCCAGCTGGAGATGGTGCGGGTGACGCCAGCGCGCG
GGGCGCCCTACTTCCTGTACGACCGCGACCACGACGGCCATACCGACGCG
GAAAAGGACAAGGTCAACAAGGTGTATTGGCAGCTCTATAGCTGGTGA
SEQ ID NO: 3
M H H H H H H S S G L V P R G S G M K E T A A A K
F E R Q H M D S P D L G T D D D D K A M A I Y A A
R P G H T A P A H T A R R S I R I T T M N K A R L
L L L P L L L L G G C A T S G G D R A G G D I P A
G A D V T S K T M G N G D K V D E Y R V N G Q L E
M V R V T P A R G A P Y F L Y D R D H D G H T D A
E K D K V N K V Y W Q L Y S W Stop

Xcb2-66; Homology to Xac 1240, Xcc
1142 hypothetical proteins

SEQ ID NO: 2
CTCGCCCTGGCCGTGCTGGCCGCGCTGTCCGCTGGCACCGCATTCGCCGC
CACCGTGCCGGCTCCCGGCGATGCGCCGCGGCCTGCCAAGCTCGACAAGA
ACGGCGATGGCGTGATCGACCGCAGCGAAGCGGCTGCCGATCCGACGCTG
GCCGCGCAGTTCGATACGTTGGACACCAACAAGGACGGCAAGCTGTCGCG
CGACGAGCGCCCGCATCATCGTGGCCCTGGGCGCGATGGGCGCGGCGGAC
GTGGCGGACGTGGCGAATGGATGGCCAAGCTCGATACCAACAAGGATGGC
CGTATCAGCCGCGAAGAAGCCAAGGCCGCCCCCAAGTTCGCTGCACGCTT
CGACCAGATGGATCTCAACAAGGACGGCTTCGTCGACCGTGCCGACCGTG
AGTTGCGCATGCAGCAGCATCGCGACGCGTGGTTTGCCAAGGCCGATACC
GACAAGGACGGCAAGCTGAGCAAGGCCGAGTTCGATGCCGCGTCCAAGTG
GCGTGGCGGGCACGGACCGGGTGGGATGGGCAGGCACGGCGACGATGGCA
AGCCGGCACCGCCGCCGCACCTGCGACGAACCGCTGAGGCATCGCCGACT
GCGGCACTCGTTGCGTATTGGCGAGTGCCGCTTGGGTGA
SEQ ID NO: 4
L A L A V L A A L S A G T A F A A T V P A P G D A
P R P A K L D K N G D G V I D R S E A A A D P T L
A A Q F D T L D T N K D G K L S R D E R P H H R G
P G R D G R G G R G G R G E W M A K L D T N K D G
R I S R E E A K A A P K F A A R F D Q M D L N K D
G F V D R A D R E L R M Q Q H R D A W F A K A D T
D K D G K L S K A E F D A A S K W R G G H G P G G
M G R H G D D G K P A P P P H L R R T A E A S P T
A A L V A Y W R V P L G Stop

We claim:

1. A method of isolating a polynucleotide of a microbe that is specifically expressed during infection of a plant comprising:
(a) obtaining a plant tissue that is infected with the microbe;
(b) immunizing an animal with the infected plant tissue;
(c) collecting antibodies from the immunized animal;
(d) adsorbing the antibodies with cells and/or extracts of the microbe grown in vitro;
(e) isolating unadsorbed antibodies; and
(f) probing a library of the microbe's DNA or RNA with the unadsorbed antibodies,
wherein the library is an expression library or display library;
wherein a polynucleotide of the microbe that is specifically expressed during infection of the plant is isolated.

2. The method of claim 1, further comprising determining the nucleotide sequence of the isolated polynucleotide.

3. The method of claim 1, further comprising expressing a polypeptide from the isolated polynucleotide.

4. The method of claim 3, further comprising generating an antibody specific for the polypeptide.

5. The method of claim 1, wherein the animal is selected from the group consisting of humans, baboons, chimpanzees, macaques, cattle, sheep, pigs, horses, goats, dogs, cats, rabbits, guinea pigs, rats, mice, chickens, and ducks.

6. The method of claim 1, wherein the plant tissue of (a) is obtained from two or more plants.

7. The method of claim 1, wherein the microbe is selected from the group consisting of a bacterium, a virus, a viroid, a parasite, a yeast, and a fungus.

8. The method of claim 1, wherein the plant tissue is selected from the group consisting of a leaf, root, stem, flower, seed, and fruit.

9. The method of claim 1, wherein the immunization of an animal comprises immunizing the animal with a composition comprising a plant tissue that has been homogenized and an adjuvant.

10. The method of claim 1, wherein the library is a plasmid genomic expression library or a bacteriophage display library.

11. The method of claim 1, wherein probing a library comprises:
(a) immobilizing the unadsorbed antibodies on a solid support;
(b) adding the library of the microbe's DNA or RNA to the solid support;
(c) washing unbound members of the library from the solid support;
(d) recovering members of the library that are bound to the solid support.

12. The method of claim 11, wherein the members of the library are phage particles.

13. The method of claim 11, wherein the solid support is blocked with a blocking agent before the library is added.

14. The method of claim 11, wherein the solid support is selected from the group consisting of nitrocellulose, nylon, polystyrene, polyvinylchloride, latex, fiberglass, glass, microsphere, liposome, sepharose, sephadex, and a magnetic particle.

15. The method of claim 1, wherein the plant tissue comprises a plurality of plant tissues that are collected at different timepoints during microbial infection of the plant.

16. The method of claim 1, wherein the plant is selected from the group consisting of algae, bryophytes, tracheophytes and angiosperms.
